(19) United States
(12) Patent Application Publication
(10) Pub. No.: US 2016/0316022 A1
(43) Pub. Date: Oct. 27, 2016

(54) COMMUNICATION DEVICE, COMMUNICATION PROCESSING METHOD, AND STORAGE MEDIUM

(71) Applicant: FUJITSU LIMITED, Kawasaki-shi (JP)

(72) Inventors: Yosuke TAKANO, Kawasaki (JP); Naoki OGUCHI, Kawasaki (JP); Ryoichi MUTOH, Kawasaki (JP)

(21) Appl. No.: 15/096,991

(22) Filed: Apr. 12, 2016

(30) Foreign Application Priority Data
Apr. 23, 2015 (JP) 2015-088728

(51) Int. Cl. H04L 29/08; H04L 12/26; H04L 29/06

(52) U.S. Cl. CPC H04L 67/141; H04L 69/18; H04L 43/0888

(57) ABSTRACT

A communication device including: a memory, and a processor coupled to the memory and configured to: receive a connection request that requests a session, calculate a processing load on processing of an ongoing session, determine, when the processing load exceeds a threshold, each protocol for each of the requested session and the ongoing session based on a comparison of a first throughput and a second throughput, the first throughput being an estimated throughput when a first protocol is to be used for the requested session and the ongoing session, the second throughput being an estimated throughput when a second protocol is to be used for at least one of the requested session and the ongoing session, a processing load of the second protocol being smaller than a processing load of the first protocol, and process each of the requested session and the ongoing session using each determined protocol.

### CROSS-REFERENCE TO RELATED APPLICATION

This application is based upon and claims the benefit of priority of the prior Japanese Patent Application No. 2015-088728, filed on Apr. 23, 2015, the entire contents of which are incorporated herein by reference.

### FIELD

The embodiments discussed herein are related to communication processing in a network including a plurality of devices.

### BACKGROUND

Transmission Control Protocol (TCP) is used in communication between a plurality of devices in many cases. However, in the communication using the TCP, when discarding of a packet occurs, a transmission rate greatly decreases, and a throughput is not easily obtained. For this reason, in a case where a round trip time (RTT) is long, such as communication between overseas bases, or in communication via a network with a high packet loss rate, such as a wireless network, efficiency tends to decrease if the TCP is used. Therefore, there are an increasing number of cases where the speed of data transmission is enhanced by using a wide area network (WAN) accelerator. The WAN accelerator is installed on each of both ends of a network on the client side and the server side. The WAN accelerator having received a TCP packet from a client device converts a protocol to be used in a packet into a high-speed communication protocol, and then transfers the packet to the WAN accelerator on the server side. The WAN accelerator on the server side converts the packet received from the WAN accelerator on the client side, into a TCP packet and then transfers the TCP packet to a server.

Here, in the communication using the high-speed communication protocol, a processing load is higher than that in the communication based on the TCP, due to conversion from the TCP to the high-speed communication protocol, communication processing based on the high-speed communication protocol, and the like, in many cases. Therefore, a vendor selling a WAN accelerator sets an upper limit for the number of flows processible using the high-speed communication protocol in the WAN accelerator, according to performance of a processor included in the WAN accelerator. Until the upper limit set in this accelerator is reached, this WAN accelerator transmits flows to processed, by using the high-speed communication protocol. However, flows for which communications begin after the upper limit is reached are processed with the TCP.

As a related technique, there is proposed a method of controlling a communication path, in an environment providing a WAN acceleration technique in a virtual machine. In this method, when a failure occurs in an application of a communication service of the virtual machine, a communication path and a communication method of the virtual machine are changed according to the application having the failure (for example, Japanese Laid-open Patent Publication No. 2014-138407). There is also proposed a transmission device that performs control of an encoding speed of stream data to be transmitted, and performs error-resistance control, based on a communication status measured based on a transmission acknowledgement packet (for example, Japanese Laid-open Patent Publication No. 2006-129277). There is also proposed a performance prediction method using response characteristic information, which is generated from a difference in reception time between a command frame and a response thereto in an operating network, as load data of a transmission channel actually operating (for example, Japanese Laid-open Patent Publication No. 07-58760).

### SUMMARY

According to an aspect of the invention, a communication device includes a memory, and a processor coupled to the memory and configured to: receive a connection request that requests a session, calculate a processing load on processing of an ongoing session, determine, when the processing load exceeds a threshold, each protocol for each of the requested session and the ongoing session based on a comparison of a first throughput and a second throughput, the first throughput being an estimated throughput when a first protocol is to be used for the requested session and the ongoing session, the second throughput being an estimated throughput when a second protocol is to be used for at least one of the requested session and the ongoing session, a processing load of the second protocol being smaller than a processing load of the first protocol, and process each of the requested session and the ongoing session using each determined protocol.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram for describing an example of a communication processing method according to an embodiment;

FIG. 2 is a diagram for describing an example of a configuration of a communication device;

FIG. 3 is a diagram for describing an example of a hardware configuration of the communication device;

FIG. 4 is a diagram illustrating an example of a transfer-destination table and an example of a path-status table;

FIG. 5 is a diagram illustrating an example of a format of a packet;

FIG. 6 is a diagram illustrating an example of a format of a packet;

FIG. 7 is a diagram illustrating an example of a session management table;

FIGS. 8A to 8B are a sequence diagram for describing an example of processing when a new flow occurs;

FIG. 9 is a diagram illustrating an example of a table to be used for a prediction of a throughput;

FIG. 10 is a flowchart for describing an example of processing of the communication device;

FIG. 11 is a diagram for describing an example in which a difference between throughputs to be obtained by the respective protocols varies depending on session;

FIGS. 12A to 12B are a sequence diagram for describing an example of processing to be performed in a second embodiment;

FIG. 13 is a diagram for describing an example of a prediction value of a throughput;

FIG. 14 is a flowchart for describing an example of processing to be performed in the second embodiment;

FIGS. 15A to 15B are a sequence diagram for describing an example of processing to be performed in a third embodiment;

FIG. 16 is a diagram for describing an example of a throughput prediction method;

FIGS. 17A to 17B are a sequence diagram for describing an example of processing to be performed in a fourth embodiment; and

FIG. 18 is a diagram for describing an example of a prediction value of a throughput.

### DESCRIPTION OF EMBODIMENTS

In a case where an upper limit is set to the number of flows processible with a high-speed communication protocol by a WAN accelerator, a maximum number of flows to be transferred with the high-speed communication protocol is fixed, regardless of the type of data to be transferred in each flow and the state of a transfer path. The upper limit for the flows processible with the high-speed communication protocol is determined based on a throughput of an average flow or a prediction of an average value of processing loads in the WAN accelerator. However, the throughput in transfer of a flow may fluctuate depending on the state of a transfer path, and the processing load in the WAN accelerator may vary depending also on the flow. For this reason, even if the upper limit for the flows is uniformly determined, it is difficult to assign an optimum protocol, and communication processing becomes inefficient in many cases.

Embodiments are intended to enhance communication efficiency.

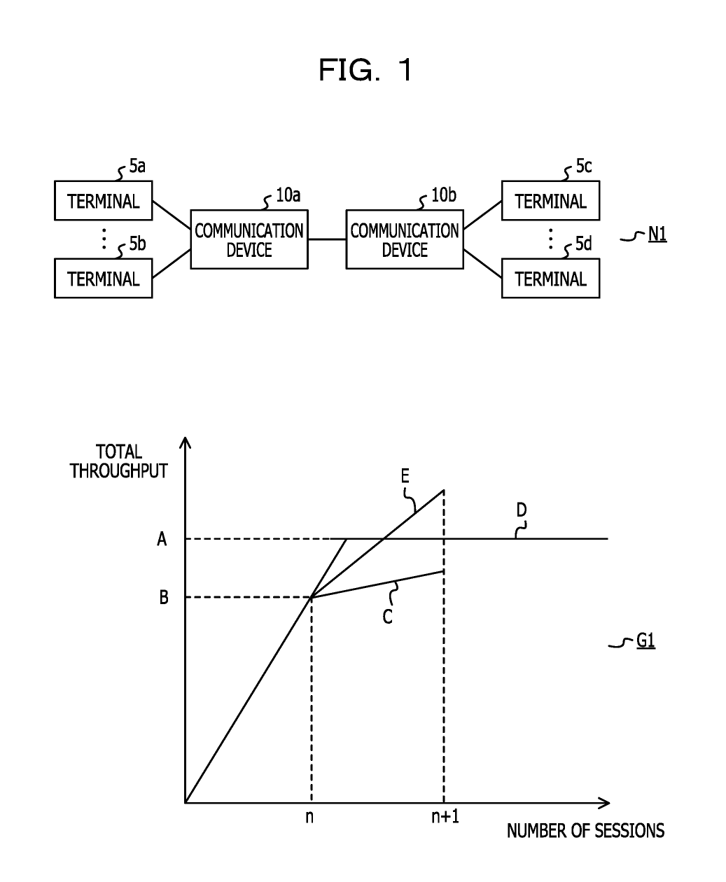

FIG. 1 is a diagram for describing an example of a communication processing method according to an embodiment. A network N1 represents an example of a network to which the communication processing method is applied. The network N1 includes a plurality of terminals 5 (5a to 5d), a communication device 10a, and a communication device 10b. The plurality of terminals 5 communicate with each other via the communication device 10a and the communication device 10b. In the network N1, only the four terminals 5a to 5d are illustrated as the terminals 5, for easy understanding of FIG. 1, but the number of the terminals 5 in the network is arbitrary. Similarly, although the two or more communication devices 10 may be included in the network, the case where the two communication devices 10a and 10b are included in the network N1 is described as an example, with reference to FIG. 1. The communication device 10b and the communication device 10a are each assumed to be capable of communicating using both TCP and a high-speed communication protocol. In addition, the communication device 10a and the communication device 10b each monitors the number of sessions in which communication is performed using a line between the communication device 10a and the communication device 10b, and a total value of throughputs obtained in the respective sessions.

A graph G1 in FIG. 1 is an example of a relationship between the total value of the throughputs of the respective sessions processed in the communication device 10b and the number of the sessions being in communication (namely, ongoing sessions). In the graph G1, “A” represents an upper limit for throughputs to be obtained when the communication device 10b processes all the sessions using the high-speed communication protocol. For example, assume that n sessions are established between the communication device 10a and the communication device 10b. Further, assume that the sessions being in communication are all processed with the high-speed communication protocol. In this case, as indicated by “B” in the graph G1, the total throughput is a value lower than the upper limit A for the throughputs to be obtained using the high-speed communication protocol.

Next, assume that, after a processing load in the communication device 10b exceeds a predetermined threshold, the terminal 5a starts communication with the terminal 5c via the communication device 10a and the communication device 10b. Here, the predetermined threshold is a value at which, if a new flow, in addition to a flow being currently processed, is processed with the high-speed communication protocol, the total value of the throughput of the flow being currently processed and the throughput of the new flow is expected to be the upper limit for the throughputs using the high-speed communication protocol.

The terminal 5a transmits a connection request for a session to the terminal 5c, to establish the session with the terminal 5c. The communication device 10a receives the connection request for the session. The communication between the terminal 5a and the terminal 5c is performed via the communication device 10b. Therefore, the communication device 10a transmits an establishment request for the session between the terminal 5a and the terminal 5c, to the communication device 10b.

Upon receiving the establishment request for the session, the communication device 10b determines an upper limit for throughputs to be obtained when the communication device 10b uses the high-speed communication protocol. Here, since the processing load of the communication device 10b exceeds the threshold, the upper limit also serves as a prediction value (a second prediction value) of throughputs when the communication device 10b processes a communication session between the terminal 5a and the terminal 5c with the high-speed communication protocol, in addition to the n sessions being currently processed. Therefore, as indicated by “D” in the graph G1 illustrated in FIG. 1, the second prediction value matches with the upper limit A for the throughputs when the high-speed communication protocol is used.

The communication device 10b processes some of the sessions with the TCP, and also determines a prediction value (a first prediction value) of throughputs to be obtained when the remaining sessions are processed with the high-speed communication protocol. Here, a throughput to be obtained when a new session to be established is processed with the TCP fluctuates depending on the status of the communication path between the communication device 10a and the communication device 10b. For example, when a round trip time (RTT) between the terminal 5a and the terminal 5c is long and a packet loss rate is high, the throughput when using the TCP decreases. For this reason, the first prediction value is lower than the upper limit (A) for the throughputs to be obtained with the high-speed communication protocol, as indicated by “C” in the graph G1. On the other hand, when the RTT between the communication device 10a and the communication device 10b is short and the packet loss rate is low, the throughput when using the TCP increases. In this case, as indicated by “E” in the graph G1, the first prediction value is larger than that in the case (D) where the session to be used in the communication between the terminal 5a and the terminal 5c is processed with the high-speed communication protocol.

By using a comparison result between the first prediction value and the second prediction value, the communication device 10b determines a protocol to be used for the processing of the new session to be established. For example, assume that, if the new session to be established is processed with the TCP, only a total throughput, which is lower than that in the case where all the sessions are processed with the high-speed communication protocol, is obtained, as indicated by “C” in the graph G1. In this case, the communication device 10b determines that the new session to be established is to be processed with the high-speed communication protocol.

On the other hand, assume that, if the new session to be established is processed with the TCP, a total throughput, which is higher than that in the case where all the sessions are processed with the high-speed communication protocol, is obtained, as indicated by “E” in the graph G1. In this case, the communication device 10b determines that the new session to be established is to be processed with the TCP.

The communication device 10b notifies the communication device 10a of the determined protocol. Then, the communication device 10a processes the session to be used for the communication between the terminal 5a and the terminal 5c, by using the protocol notified of by the communication device 10b.

In this way, in the communication processing method according to the embodiment, the protocol to be used for the processing of the new session is determined in such a manner that when the processing load on the communication device 10 exceeds the predetermined value, the total throughput of each session being in communication and the new session becomes a maximum. Therefore, the number of sessions to be processed with the high-speed communication protocol may be optimized in consideration of a factor such as the status of the communication path between the communication devices 10. As a result communication efficiency is enhanced.

In addition, for a vendor, there is such an advantage that, even if the vendor sells a program for causing an arbitrary information processing device such as a computer to operate as the communication device 10 according to the embodiment, providing an optimum service for a use environment of a user may be guaranteed. In other words, when a processing load on the device on which the program is installed by the user exceeds a predetermined value, the device itself calculates a prediction value of a throughput to be obtained for a session to be processed, and determines a protocol using the prediction value. Therefore, processing in an optimum environment is guaranteed.

<Example of Device Configuration>

In the following description, a case where the high-speed communication protocol and the TCP are each used as a protocol of a transport layer is described as an example. However, the protocol of the transport layer to be used other than the high-speed communication protocol may be an arbitrary protocol other than the TCP.

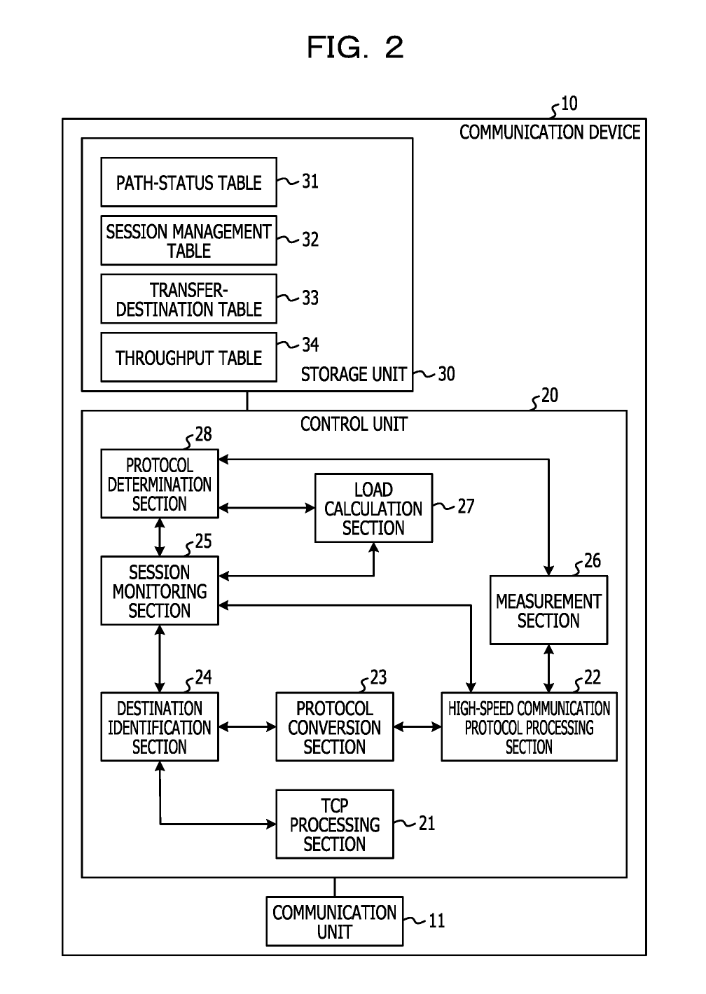

FIG. 2 is a diagram for describing an example of a configuration of the communication device 10. The communication device 10 includes a communication unit 11, a control unit 20, and a storage unit 30. The control unit 20 includes a TCP processing section 21, a high-speed communication protocol processing section 22, a protocol conversion section 23, a destination identification section 24, a session monitoring section 25, a measurement section 26, a load calculation section 27, and a protocol determination section 28. The storage unit 30 stores a path-status table 31, a session management table 32, a transfer-destination table 33, and a throughput table 34. The throughput table 34 is information in which a packet loss rate and a RTT are associated with a value of a throughput when the TCP is used.

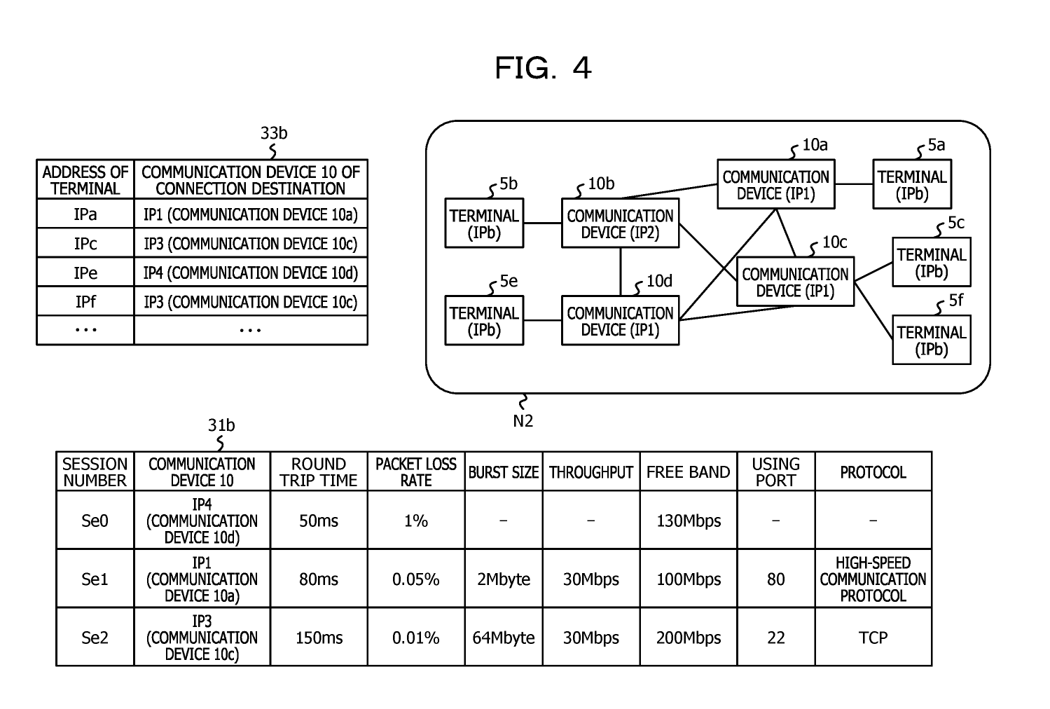

The communication unit 11 transmits and receives packets to and from the other communication device 10 and the terminal 5. The TCP processing section 21 processes a session for which the TCP is used. The high-speed communication protocol processing section 22 processes a session for which the high-speed communication protocol is used. When acquiring a connection request for a session from the terminal 5 and performing processing of transmission to the other communication device 10, the high-speed communication protocol processing section 22 determines a destination of the connection request, by using the transfer-destination table 33 (FIG. 4), appropriately. The protocol conversion section 23 converts a TCP packet into a packet corresponding to the high-speed communication protocol, and converts a packet corresponding to the high-speed communication protocol into a TCP packet, appropriately. The destination identification section 24 identifies the terminal 5 serving as the final destination, for a TCP packet generated in the protocol conversion section 23. Further, the destination identification section 24 outputs a packet to be subjected to protocol conversion to the protocol conversion section 23, and outputs a TCP packet not to be subjected to the protocol conversion to the TCP processing section 21, among TCP packets received from the terminal 5.

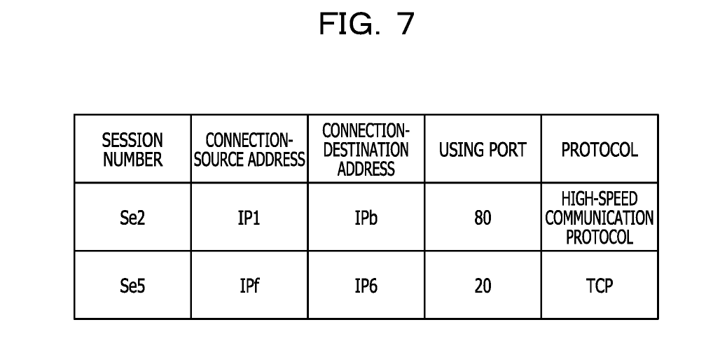

The session monitoring section 25 manages information of an established session, by using the session management table 32 (FIG. 7). The session management table 32 includes information such as a protocol to be used in each session. By using packets transmitted to and received from the counterpart communication device 10, the measurement section 26 acquires information such as a RTT, a packet loss rate, and an amount of data transmittable/receivable per unit time, and stores the acquired information in the path-status table 31 (FIG. 4). An example of each of the path-status table 31 and the session management table 32 will be described later. The load calculation section 27 calculates a processing load on the communication device 10. For example, a utilization rate of a processor included in the communication device 10 is used as the processing load. The protocol determination section 28 determines which one of the high-speed communication protocol and the TCP is to be used for a session being in communication or a session for which establishment is requested. The processing of the protocol determination section 28 will be described later in detail.

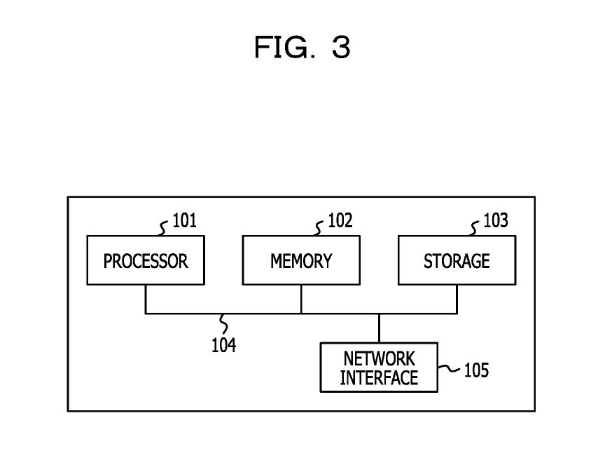

FIG. 3 is a diagram for describing an example of a hardware configuration of the communication device 10. The communication device 10 includes a processor 101, a memory 102, a storage 103, a bus 104, and a network interface 105. The processor 101 may be an arbitrary processing circuit including a central processing unit (CPU). The processor 101 reads a program stored in the storage 103, and executes the read program, thereby operating as the control unit 20. The memory 102 and the storage 103 implement the storage unit 30. The memory 102 also holds data to be used for processing in the processor 101, data obtained in the processing of the processor 101, and the like. The network interface 105 operates as the communication unit 11. The bus 104 connects the processor 101, the memory 102, the storage 103, and the network interface 105 to allow input and output of data to and from each other.

<Example of Format of Packet and Example of Table>

To clarify the communication device 10 performing processing, the same alphabet as an identifier assigned to the communication device 10 may be added to the end of the reference character of each component, in the following description. For example, the control unit 20a corresponds to the control unit 20 included in the communication device 10a.

FIG. 4 illustrates an example of the transfer-destination table 33 and an example of the path-status table 31. FIG. 4 illustrates each of the tables of the communication device 10b included in a network N2, as an example. In the network N2, the communication devices 10a to 10d are connected to each other. Further, the terminal 5a is connected to the communication device 10a, the terminal 5b is connected to the communication device 10b, and the terminal 5e is connected to the communication device 10d. Furthermore, the terminal 5c and the terminal 5f are connected to the communication device 10c.

In the transfer-destination table 33, information of the communication device 10 to be a transfer destination of a packet destined for the terminal 5 is recorded, by being associated with the address of the terminal 5 capable of performing communication via the other communication device 10. For example, in a first entry of the transfer-destination table 33b of the communication device 10b, there is a record indicating that communication with the terminal 5a that is assigned an address of “IPa” is allowed to perform communication via the communication device 10a that is assigned “IP1”. Also recorded in the transfer-destination table 33b are the other terminals 5, with which the terminal 5b connected to the communication device 10b are allowed to communicate using the high-speed communication protocol via the communication device 10b, and the information of the communication device 10 to be a connection destination in the communication with each of these terminals 5.

The path-status table 31b illustrated in FIG. 4 includes a session number, the address of the communication device 10 that is a communication destination, a RTT, a packet loss rate, a burst size, a throughput, a free band, a using port, and a protocol. In the following description, “free band” is a transmission rate, which may be used in a section between the communication device 10b and the communication device 10 being measured, in addition to a transmission rate of the current communication. When a communication session is established in the section being measured, the measurement section 26 determines a RTT, a packet loss rate, a throughput, and the like by using packets transmitted and received in the communication session, and records the results in the path-status table 31 by associating the results with a session number. Further, the measurement section 26 monitors the amount of data transmitted and received in the communication session, thereby recording the burst size as well, by associating the burst size with the session number. Furthermore, a using port and a protocol are also associated with the session number, and recorded in the path-status table 31. When a plurality of sessions are established in a section identified by the two communication devices 10, the same number of pieces of information as the number of the sessions may be associated with the section and stored in the path-status table 31.

For example, assume that the communication device 10b establishes a session Se1 with the communication device 10a, and establishes a session Se2 with the communication device 10c, but establishes no session with the communication device 10d. In this case, by using packets transmitted and received in the session Se1, the measurement section 26b of the communication device 10b determines information such as a RTT between the communication device 10b and the communication device 10a, and records the determined information in the path-status table 31b. In addition, by using packets transmitted and received in the session Se2, the measurement section 26b determines information about the status of a path between the communication device 10b and the communication device 10c, and records the determined information in the path-status table 31b.

On the other hand, to acquire information about a section between the communication devices 10 where no session is established, such as a section between the communication device 10b and the communication device 10d, the measurement section 26 transmits and receives measurement packets to and from the counterpart communication device 10. The measurement section 26 acquires information about a communication path for the counterpart communication device 10, by analyzing the measurement packets. Here, the measurement packets are arbitrary packets that may be used to acquire these pieces of information. For easy understanding of the information obtained using the measurement packets, an invalid value such as Se0 is used in the path-status table 31, as the session number for the section where no session is generated.

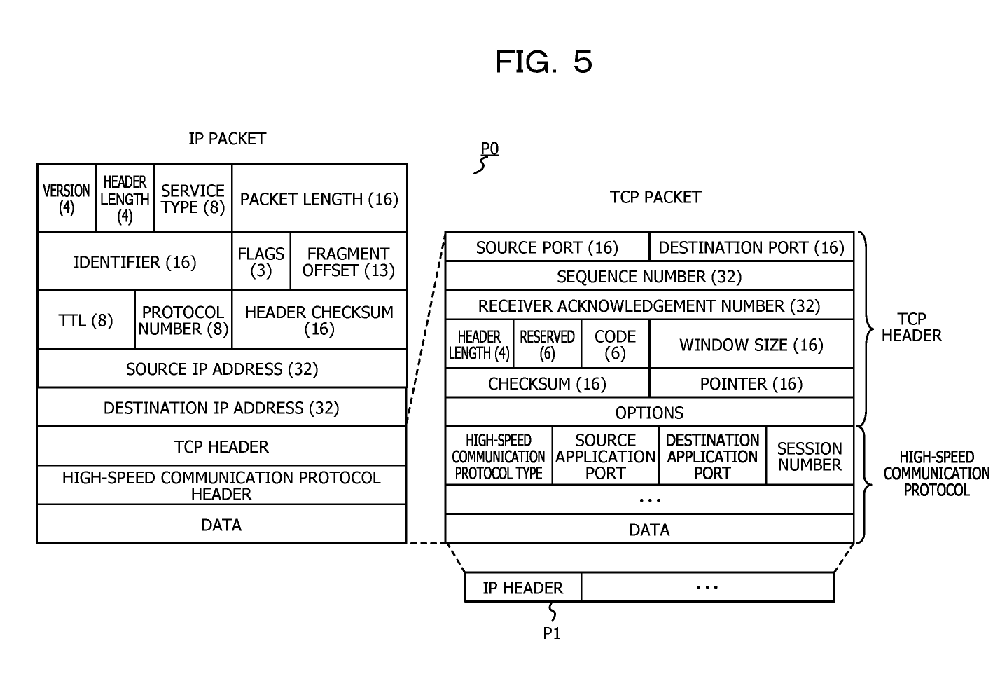

FIG. 5 illustrates an example of a format of a packet when the high-speed communication protocol is used between the communication devices 10. A packet to be transmitted and received in communication using the high-speed communication protocol includes an Internet protocol (IP) header, a TCP header, a high-speed communication protocol header, and data. When the high-speed communication protocol is used, a packet P1 transmitted from the terminal 5 to the communication device 10 corresponds to data following a control header of the high-speed communication protocol as illustrated in FIG. 5. In other words, a packet PO to be transmitted using the high-speed communication protocol is a packet formed by adding an IP header, a TCP header, a control header of the high-speed communication protocol, and the like to be used in transmission and reception with respect to the communication device 10, to outside of an IP header of the packet P1 to be transferred. Adding the IP header, the TCP header, the control header of the high-speed communication protocol, and the like is performed by the protocol conversion section 23. In the following, for easy understanding, a word “outer” is affixed to a header added by the protocol conversion section 23, and a word “inner” is affixed to a header of a packet included as data. For example, an IP header added by the protocol conversion section 23 may be referred to as “outer IP header”, and an IP header of a packet included as data may be referred to as “inner IP header”.

The outer IP header includes version information, a header length, a service type, a packet length, a packet identifier, flags, a fragment offset, time to live (TTL), a protocol number, a header checksum, a source IP address, and a destination IP address. The IP header is similar to an IP header used in known communication processing. The TCP header includes a source port number, a destination port number, a sequence number, a receiver acknowledgement number, a header length, reserved bits, a code, a window size, a checksum, a pointer, and options. In the TCP header (the outer TCP header) when the high-speed communication protocol is used, the window size is set beforehand, not to perform window control and slow start.

The high-speed communication protocol header includes a high-speed communication protocol type, a source application port, a destination application port, a session number, and the like. The information included in each of the outer IP header, the outer TCP header, and the high-speed communication protocol header is used in generation of the session management table 32. The generation of the session management table 32 will be described with reference to FIG. 7.

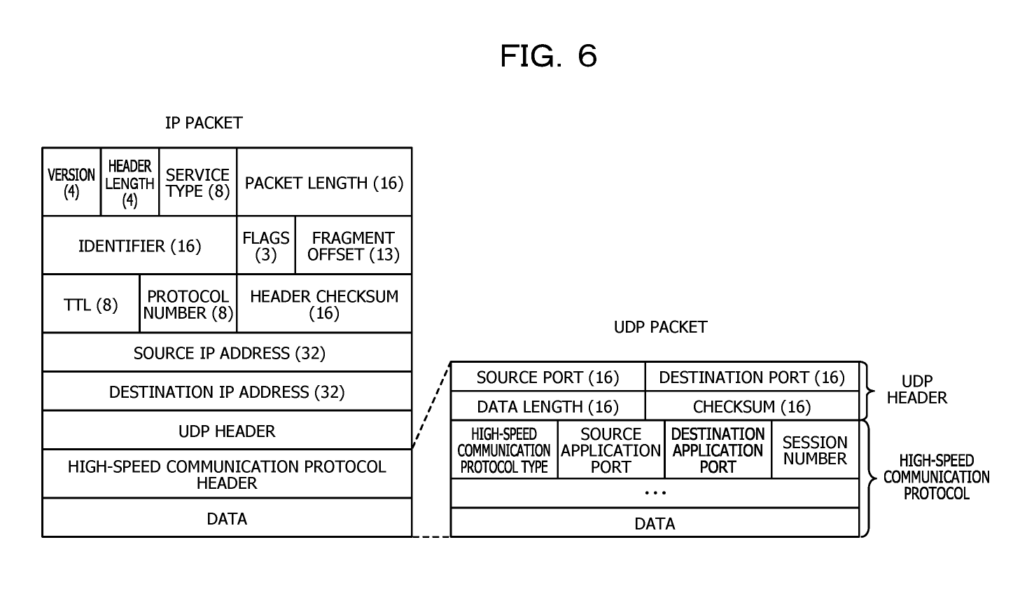

FIG. 6 illustrates an example of a format of a packet when the high-speed communication protocol is used. FIG. 6 illustrates an example of a format when User Datagram Protocol (UDP) is used as a protocol of a transport layer. A packet illustrated in FIG. 6 includes an outer IP header, a UDP header (an outer UDP header), a high-speed communication protocol header, and data. As described with reference to FIG. 5, a packet P1 transmitted from the terminal 5 to the communication device 10 is handled as data following the control header of the high-speed communication protocol by the protocol conversion section 23. Information elements included in the outer IP header and the high-speed communication protocol header are similar to those described with reference to FIG. 5. The UDP header includes a source port number, a destination port number, a data length, and a checksum. The outer IP header and the UDP header are similar to those used in known communication processing. The information included in each of the outer IP header, the UDP header, and the high-speed communication protocol header is used in generation of the session management table 32.

FIG. 7 is a diagram illustrating an example of the session management table 32. In the session management table 32, a connection-source address, a connection-destination address, a using port, and a protocol are recorded by being associated with a session number. Each time the communication device 10 receives a connection request for a session, the session management table 32 is updated by the session monitoring section 25. The session monitoring section 25 extracts the source IP address of the IP header of the connection request for the session, as the connection-source address. When the received packet is a packet using the high-speed communication protocol, the source IP address of the outer IP header is used as the connection-source address. The connection-destination address is identified by the destination address of the inner IP header.

On the other hand, when the high-speed communication protocol is not used in the connection request, the session monitoring section 25 searches through the transfer-destination table 33, by using the destination address in the IP header, as a key. The session monitoring section 25 assumes that the address of the communication device 10 associated with the destination address of the connection request in the transfer-destination table 33 is the connection-destination address.

Further, the session monitoring section 25 acquires the port of the last destination, as the using port. When the received packet is a packet using the high-speed communication protocol, the destination port of the inner TCP header is extracted as the using port. On the other hand, when the received packet is a packet using the TCP, the address port of the TCP header is extracted as the using port.

### FIRST EMBODIMENT

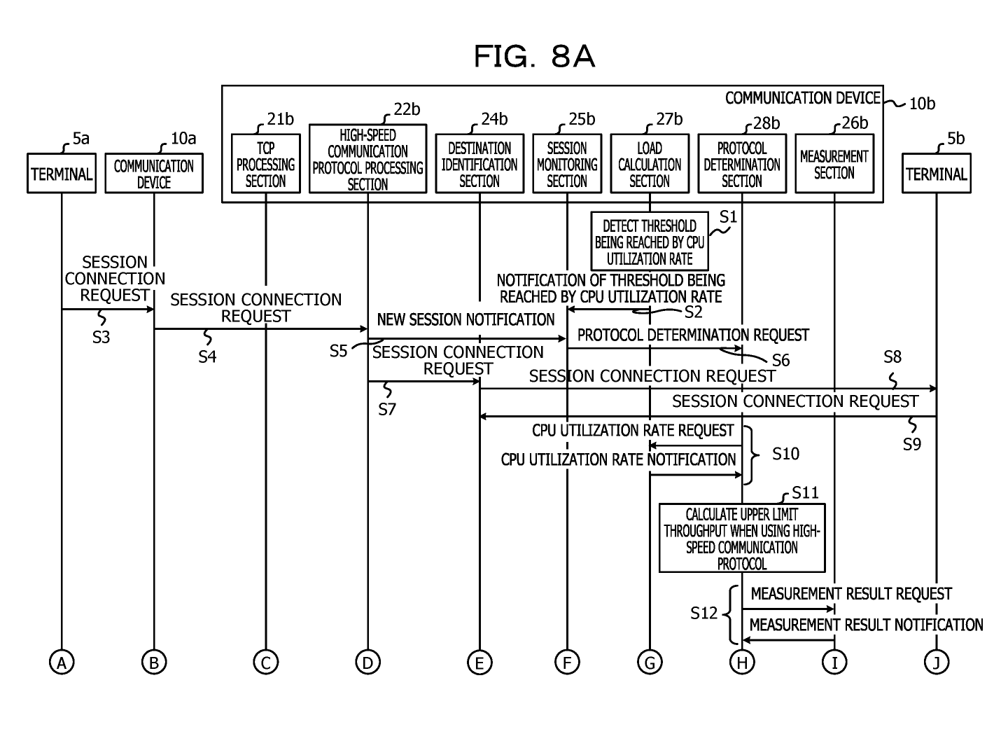

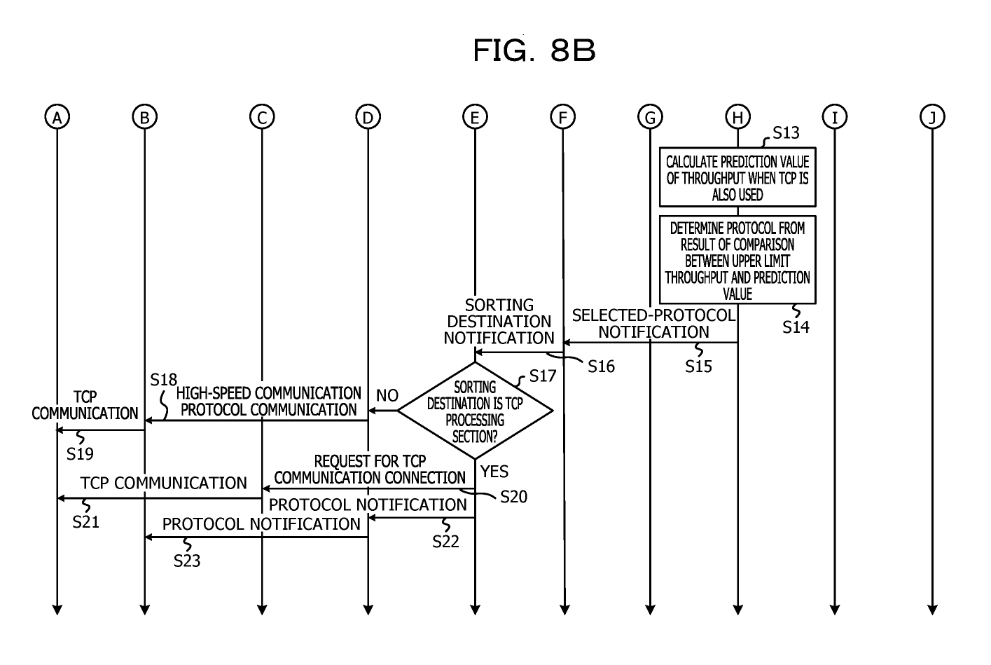

FIGS. 8A to 8B are a sequence diagram for describing an example of processing in a case where a new flow occurs when a processing load on the communication device 10 is higher than a threshold Th. The processing will be described below in detail with reference to FIGS. 8A to 8B, by using, as an example, a case where the utilization rate of the CPU included in the communication device 10 is used as the load on the communication device 10. The threshold Th is a value at which, if a new flow, in addition to a flow being currently processed, is processed with the high-speed communication protocol, the total value of the throughput of the flow being currently processed and the throughput of the new flow is expected to be the upper limit for the throughputs using the high-speed communication protocol.

In the example illustrated in FIGS. 8A to 8B, the terminal 5a is assumed to be connected to the communication device 10a, and the terminal 5b is assumed to be connected to the communication device 10b, as illustrated in the network N2 in FIG. 4. Further, the terminal 5a is assumed to store beforehand information indicating that communication with the terminal 5b is to be performed via the communication device 10a.

The load calculation section 27b periodically calculates the utilization rate of the CPU. The utilization rate of the CPU may be determined by an arbitrary method, and is determined as, for example, the product of the number of sessions being in communication and a coefficient representing a load on processing of the sessions. The coefficient representing the load is determined according to implementation. The load calculation section 27b compares the determined utilization rate with the threshold Th stored beforehand. Here, the threshold Th is a value at which, if the high-speed communication protocol is used in establishment of a new session, a throughput to be obtained is expected to be an upper limit when the high-speed communication protocol is used. The threshold Th is set according to an empirical rule and implementation. Upon detecting the threshold Th being reached by the utilization rate of the CPU, the load calculation section 27b notifies the session monitoring section 25b that the threshold Th is reached by the utilization rate of the CPU (step S1 and step S2).

On the other hand, the terminal 5a generates a session connection request for starting communication with the terminal 5b, and transmits the generated session connection request (step S3). Upon receiving the session connection request, the communication unit 11a of the communication device 10a outputs the session connection request to the session monitoring section 25a via the destination identification section 24a. The session monitoring section 25a identifies the transfer destination of the communication with the terminal 5b is the communication device 10b, by using the transfer-destination table 33a. Then, the session monitoring section 25a outputs the session connection request, together with the information indicating that the transfer destination of the session connection request is the communication device 10b, to the protocol conversion section 23a. The protocol conversion section 23a converts the session connection request into a packet using the high-speed communication protocol destined for the communication device 10b. The high-speed communication protocol processing section 22a transmits the session connection request converted by the protocol conversion section 23a, to the communication device 10b, via the communication unit 11a (step S4).

The high-speed communication protocol processing section 22b of the communication device 10b acquires the session connection request, via the communication unit 11b. The high-speed communication protocol processing section 22b notifies the session monitoring section 25b that a new session is to be established (step S5). In this process, the high-speed communication protocol processing section 22b also outputs header information and payload information included in the session connection request, to the session monitoring section 25b. The session monitoring section 25b adds the following information to the session management table 32b, by using the information input from the high-speed communication protocol processing section 22b.

Session number: Se2

Connection-source address: address of communication device 10a

Connection-destination address: address of terminal 5b

Since the session monitoring section 25b is notified that the threshold Th is exceeded by the utilization rate of the CPU in step S2, the session monitoring section 25b requests the protocol determination section 28b to determine a protocol, without recording protocol information in the session management table 32 (step S6).

In parallel with the processing in step S5 and step S6, the communication device 10b also performs establishment of the session with the terminal 5b. The high-speed communication protocol processing section 22b outputs the session connection request to the destination identification section 24b via the protocol conversion section 23b (step S7). The session connection request is converted into a TCP packet destined for the terminal 5b, by processing in the protocol conversion section 23b. The destination identification section 24b transmits the session connection request to the terminal 5b via the communication unit 11b (step S8).

Upon receiving the session connection request destined for the terminal 5b from the terminal 5a, the terminal 5b transmits a session connection request toward the terminal 5a, for communication in a direction from the terminal 5b to the terminal 5a. Here, since the terminal 5b stores beforehand information indicating communication with the other terminal 5 via the communication device 10b, the terminal 5b transmits the session connection request to the communication device 10b (step S9). The destination identification section 24b acquires the session connection request destined for the terminal 5a from the terminal 5b, via the communication unit 11b.

Next, protocol determination processing that is caused by the processing in step S6 will be described with reference to step S10 to step S16. When determination of a protocol is requested, the protocol determination section 28b acquires the latest value of the CPU utilization rate from the load calculation section 27b (step S10). The protocol determination section 28b predicts an upper limit throughput when all the remaining CPU resources are used for the processing of the high-speed communication protocol (step S11). For example, in a case where the CPU utilization rate obtained in step S10 is 90%, the protocol determination section 28b calculates an upper limit for throughputs to be obtained with the high-speed communication protocol, when the CPU resources of 10% currently not being used are used for processing, in addition to the current processing for the high-speed communication protocol.

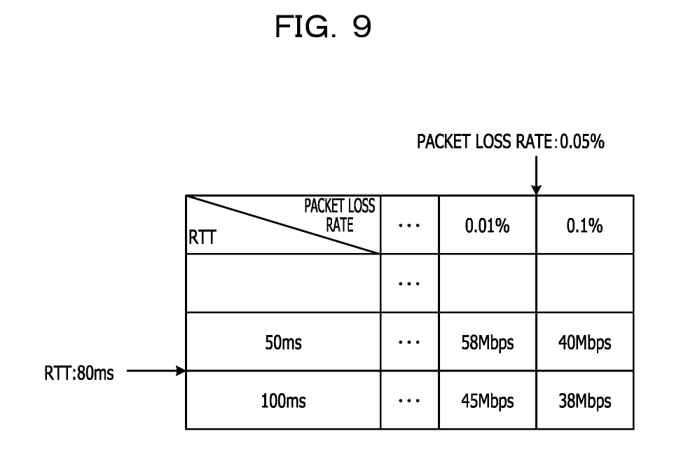

In step S12, the protocol determination section 28b notifies the measurement section 26b that the connection source is the communication device 10a, and requests a measurement result for the state of the line with the communication device 10a. The measurement section 26b searches through the path-status table 31b by using the address of the communication device 10a as a key, and notifies the protocol determination section 28b of information such as the RTT and the packet loss rate between the communication device 10b and the communication device 10a. By using the values acquired from the measurement section 26b, and the throughput table 34b, the protocol determination section 28b determines a throughput to be obtained when the TCP is used for the processing of the new session to be established. Further, by using the throughput to be obtained when the TCP is used for the processing of the new session to be established, the protocol determination section 28b calculates a prediction value of throughputs when the TCP and the high-speed communication protocol are used together (step S13). Here, the prediction value is a total value of the throughput to be obtained when the TCP is used for the processing of the new session to be established and the throughputs obtained by the sessions currently being in communication. An example of the calculation of the throughput to be obtained when the TCP is used will be described later with reference to FIG. 9.

By using the result of a comparison between the upper limit for the throughput to be obtained when the high-speed communication protocol is used and the prediction value calculated in step S13, the protocol determination section 28b determines a protocol to be used in the new session to be established, (step S14). Here, when the processing in step S14 is performed, since the CPU load exceeds the predetermined threshold Th, the total value of all the throughputs is expected to be the upper limit for the throughputs using the high-speed communication protocol if the new flow is processed with the high-speed communication protocol. Therefore, in step S14, a comparison in terms of the total throughput is made between the case where all the sessions are processed with the high-speed communication protocol and the case where the processing is performed using the high-speed communication protocol and the TCP together. If the throughput when the TCP is used is low and the prediction value is equal to or less than the upper limit for the throughputs when the high-speed communication protocol is used, the protocol determination section 28b determines that the high-speed communication protocol is to be used for the communication between the communication device 10a and the communication device 10b. On the other hand, if the throughput when the TCP is used is high and the prediction value is larger than the upper limit for the throughputs when the high-speed communication protocol is used, the protocol determination section 28b determines that the TCP is to be used for the communication between the communication device 10a and the communication device 10b. The protocol determination section 28b notifies the session monitoring section 25b of the selected protocol (step S15). The session monitoring section 25b records the protocol notified of by the protocol determination section 28b, in the session management table 32b.

When being notified that the high-speed communication protocol is to be used for the communication between the communication device 10a and the communication device 10b, the session monitoring section 25b notifies the destination identification section 24b of a sorting destination of packets to be transmitted and received in the new session to be connected (step S16). For example, when the new session to be connected is to use the high-speed communication protocol, the session monitoring section 25b notifies that the new session to be connected is to be terminated at the high-speed communication protocol processing section 22b. On the other hand, when the new session to be connected is to use the TCP, the session monitoring section 25b notifies that the new session to be connected is to be terminated at the TCP processing section 21b.

When being notified that the new session to be connected is to be terminated at the high-speed communication protocol processing section 22b (No in step S17), the destination identification section 24b outputs a packet to be used for the establishment of the session, to the high-speed communication protocol processing section 22b. In this case, the destination of the packet to be used for the establishment of the session is designated as the communication device 10a. Therefore, the high-speed communication protocol processing section 22b generates the session using the high-speed communication protocol with the communication device 10a, by transmitting the packet to the communication device 10a by using the high-speed communication protocol (step S18). Further, the high-speed communication protocol processing section 22a in the communication device 10a adds the following entries to the session management table 32a.

Session number: Se2

Connection-source address: address of terminal 5a

Connection-destination address: address of communication device 10b

Protocol: high-speed communication protocol

When the session using the high-speed communication protocol is generated for the communication device 10b, the communication device 10a establishes the TCP session for the terminal 5a (step S19). Therefore, the communication between the terminal 5a and the terminal 5b is performed via the session using the high-speed communication protocol between the communication device 10a and the communication device 10b.

On the other hand, when being notified that the new session to be connected is to be terminated at the TCP processing section 21b (Yes in step S17), the destination identification section 24b outputs a packet to be used for the establishment of the session, to the TCP processing section 21b (step S20). In this case, the destination of the packet to be used for the establishment of the session is designated as the terminal 5a. The TCP processing section 21b generates the session using the TCP with the terminal 5a, by transmitting the packet to the terminal 5a by using the TCP (step S21). Therefore, the communication between the terminal 5a and the terminal 5b is performed via the TCP session between the communication device 10a and the communication device 10b. Further, the destination identification section 24b also notifies the high-speed communication protocol processing section 22b that the new session is to be processed with the TCP (step S22). The high-speed communication protocol processing section 22b notifies the communication device 10a that the new session is to be processed with the TCP (step S23). By this processing, the communication device 10a may recognize that the communication session between the terminal 5a and the terminal 5b is to be performed with the TCP, and may update the session management table 32a in the communication device 10a. Therefore, the following information is stored in the session management table 32a in the communication device 10a.

Session number: Se2

Connection-source address: address of terminal 5a

Connection-destination address: address of communication device 10b

Protocol: TCP

After the session is established, the communication device 10a identifies a protocol to be used for processing of transmission to the communication device 10b, according to the session management table 32a. Therefore, when the high-speed communication protocol is selected as described with reference to step S18, the communication device 10a processes the packet destined for the terminal 5b and received from the terminal 5a, by using the high-speed communication protocol, and transfers the packet to the communication device 10b. On the other hand, when the TCP is used between the communication device 10a and the communication device 10b as described with reference to step S23, the communication device 10a transfers the packet destined for the terminal 5b and received from the terminal 5a, to the communication device 10b, by using the TCP.

FIG. 9 is a diagram illustrating an example of the throughput table 34. In the throughput table 34, a prediction value of a TCP throughput is recorded, as a function of a packet loss rate and a RTT. In the throughput table 34, the throughput is recorded, for two types of values of each of the packet loss rate and the RTT. There will be described, with reference to FIG. 9, an example of processing to be performed in a case where a prediction value of a TCP throughput, which is to be obtained in the path between the communication device 10a and the communication device 10b, is calculated in step S13 of FIG. 8B.

In the example of FIG. 9, for each of a case where the RTT is 50 ms and a case where the RTT is 100 ms, a throughput when the packet loss rate is 0.01% and a throughput when the packet loss rate is 0.1% are obtained. Here, assume that the RTT is 80 ms and the packet loss rate is 0.05%, between the communication device 10a and the communication device 10b. Then, the protocol determination section 28 determines a throughput in a case where the RTT is 80 ms by linear interpolation, for each of a case where the packet loss rate is 0.01% and a case where the packet loss rate is 0.1%. First, in the case where the packet loss rate is 0.01%, the throughput is 58 Mbps for the RTT=50 ms, whereas the throughput is 45 Mbps for the RTT=100 ms, and therefore, the RTT extends from 50 ms to 100 ms and thus the throughput deteriorates from 58 Mbps to 45 Mbps. For this reason, the protocol determination section 28b makes a calculation assuming that the throughput changes only by (45 Mbps−58 Mbps)/(100 ms−50 ms), as the RTT extends by 1 ms. Therefore, a throughput X when the RTT is 80 ms is determined from the following expression.

X=58 Mbps+(80 ms−50 ms)/(100 ms−50 ms)×(45 Mbps−58 Mbps)=51.2 Mbps

Similarly, a throughput Y when the packet loss rate is 0.1% and the RTT is 80 ms is determined from the following expression.

Y=40 Mbps+(80 ms−50 ms)/(100 ms−50 ms)×(38 Mbps−40 Mbps)=38.8 Mbps

Next, the protocol determination section 28b performs linear interpolation for the packet loss rate by using X and Y. Specifically, the packet loss rate deteriorates from 0.01% to 0.1% and thus, the throughput decreases from 51.2 Mbps to 38.8 Mbps. Therefore, the protocol determination section 28b determines a throughput Z when the packet loss rate is 0.05% and the RTT is 80 ms from the following expression.

Z=51.2 Mbps+(51.2 Mbps−38.8 Mbps)/(0.1%-0.01%)×(0.05%−0.01%)=45.6 Mbps

Using the prediction value of the TCP throughput obtained by such processing, the protocol determination section 28 performs a comparison between the total value of the throughputs when the new session is generated with the TCP and the upper limit for the throughputs using the high-speed communication protocol.

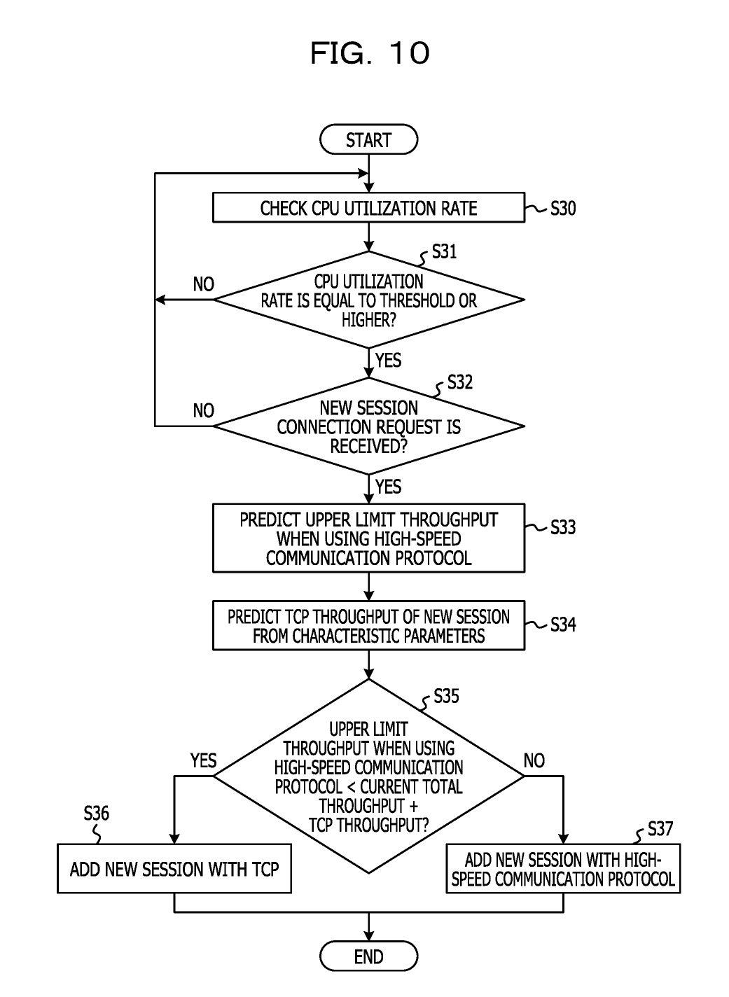

FIG. 10 is a flowchart for describing an example of processing of the communication device 10. The load calculation section 27 checks the CPU utilization rate, and determines whether the CPU utilization rate is equal to or higher than the threshold Th (step S30 and step S31). When the CPU utilization rate is less than the threshold Th (No in step S31), the processing returns to step S30. Even if the CPU utilization rate is higher than the threshold Th, the protocol determination section 28 waits until a new session connection request is received (No in step S32). When the CPU utilization rate becomes equal to or higher than the threshold Th and a new session connection request is received (Yes in step S32), the protocol determination section 28 predicts an upper limit for throughputs to be obtained with the high-speed communication protocol (step S33). From characteristic parameters of the line between the communication devices 10, the protocol determination section 28 determines, as a prediction value, a TCP throughput of the new session to be established (step S34). Here, the characteristic parameters of the line between the communication devices 10 include a RTT, a packet loss rate, and the like. The protocol determination section 28 compares the upper limit for the throughputs to be obtained with the high-speed communication protocol, with a total value of throughputs of sessions being currently processed and the TCP throughput of the new session to be established (step S35). When the upper limit for the throughput to be obtained with the high-speed communication protocol is smaller (Yes in step S35), the protocol determination section 28 determines that the new session to be established is to be added with the TCP (step S36). When the total value is smaller than the upper limit for the throughputs to be obtained with the high-speed communication protocol (No in step S35), the protocol determination section 28 determines that the new session to be established is to be established with the high-speed communication protocol (step S37).

In this way, in a case where each session being in communication is processed with the high-speed communication protocol, if the CPU utilization rate in the communication device 10 exceeds the threshold Th, the communication device 10 determines which one of the high-speed communication protocol and the TCP attains a higher throughput in processing of the new session to be established. Further, according to the result of this determination, a protocol to be used in the new session to be established is determined. Therefore, the number of sessions to be processed with the high-speed communication protocol may be optimized also considering the processing load on the communication device 10, the status of the communication path, and the like, thereby enhancing communication efficiency.

In the first embodiment, the protocol determination processing is not performed in the communication device 10a that directly receives the packet from the terminal 5a requesting the start of the session. The protocol determination processing is performed in the communication device 10b that is a counterpart device of the communication device 10a. Therefore, the first embodiment has such an advantage that, when the communication device 10a is sold to a user as a device incorporated in the terminal 5a, a load on the device operated by the user is reduced. Here, the terminal 5 is described as a terminal, for convenience in description, but examples of the terminal 5 also include a user terminal operating as a client, and a server. A request for starting a session is provided from the client terminal to the server, and therefore, in the first embodiment, it is possible to enhance communication efficiency, while reducing processing of the terminal operated by the user. Further, the amount of data to be transmitted from the server side is assumed to be larger than that on the client side, and therefore, the protocol type is determined in the communication device 10 close to the server side, thereby making it easy to enhance the communication efficiency.

### SECOND EMBODIMENT

When the processing load in the communication device 10 exceeds a threshold Th2 that is larger than the threshold Th, it is desirable to reduce the processing load immediately. Therefore, in a second embodiment, there will be described a case where, among sessions, a session with a throughput that is not easily improved even if the high-speed communication protocol is used is processed with the TCP.

In the second embodiment, when the CPU utilization rate exceeding the threshold Th2 is detected in the load calculation section 27, the session monitoring section 25 identifies a session being processed with the high-speed communication protocol, by referring to the session management table 32 (FIG. 7). When establishment of a new session is requested in the state where the processing load exceeds the threshold Th2, the protocol determination section 28 determines that the new session to be established is to be processed with the TCP. Further, for each of sessions being processed with the high-speed communication protocol, the protocol determination section 28 calculates a throughput when the TCP is used, and compares the calculated throughput with the throughput obtained with the high-speed communication protocol. Here, as described with reference to FIG. 9 in the first embodiment, the throughput when the TCP is used is calculated using the throughput table 34 appropriately. Values such as a RTT and a packet loss rate for performing linear interpolation processing using the throughput table 34 are acquired from the path-status table 31 (FIG. 4). The path-status table 31 is assumed to be updated periodically by the measurement section 26. Further, the values of the throughput of each session being processed with the high-speed communication protocol are also acquired from the path-status table 31.

For example, when the CPU utilization rate in the communication device 10b exceeds the threshold Th2, the session monitoring section 25b identifies the session Se2 being processed with the high-speed communication protocol, based on the session management table 32 in FIG. 7. Here, the session Se2 is assumed to be processed with the high-speed communication protocol, between the communication device 10a and the communication device 10b. The protocol determination section 28b acquires the status of the path between the communication device 10a and the communication device 10b when the establishment of the new session is requested, and the throughput of the session Se2, from the path-status table 31b (FIG. 4). Further, using the status of the path such as the RTT and the packet loss rate between the communication device 10a and the communication device 10b, the protocol determination section 28b calculates a prediction value of a throughput when the session Se2 changes to the TCP.

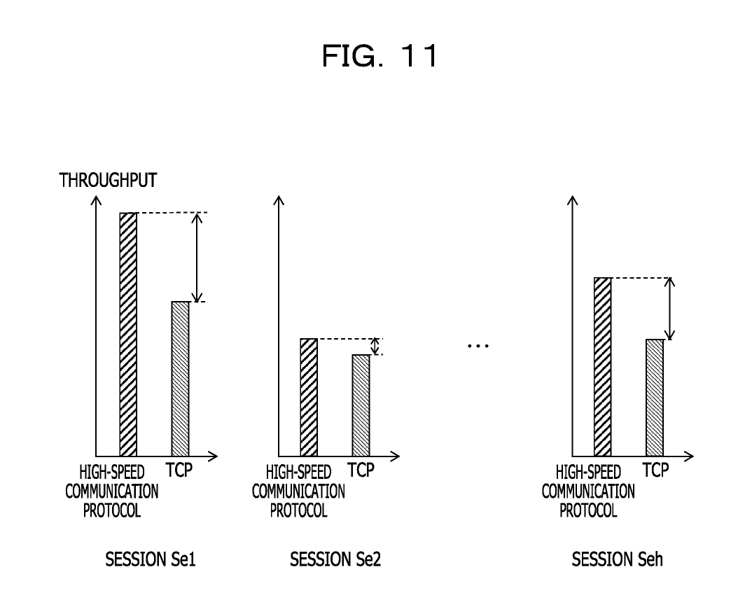

FIG. 11 illustrates, for each session being processed with the communication device 10, a throughput (a left graph) to be obtained when the session is processed with the high-speed communication protocol, and a throughput (a right graph) to be obtained when the session is processed with the TCP. The difference between the left bar graph and the right bar graph is a throughput improvement when the protocol is changed from the TCP to the high-speed communication protocol. As illustrated in FIG. 11, the throughput improvement to be obtained when the protocol is changed from the TCP to the high-speed communication protocol varies depending on session. Using such information illustrated in FIG. 11, the protocol determination section 28b preferentially selects a session in which a small throughput improvement is to be obtained by a protocol change. In the example illustrated in FIG. 11, among h sessions being processed in the communication device 10 in which the processing load of the CPU exceeds the threshold, the session Se2 indicates the smallest throughput improvement to be obtained by the protocol change. Therefore, the session Se2 is selected as a target for the protocol change.

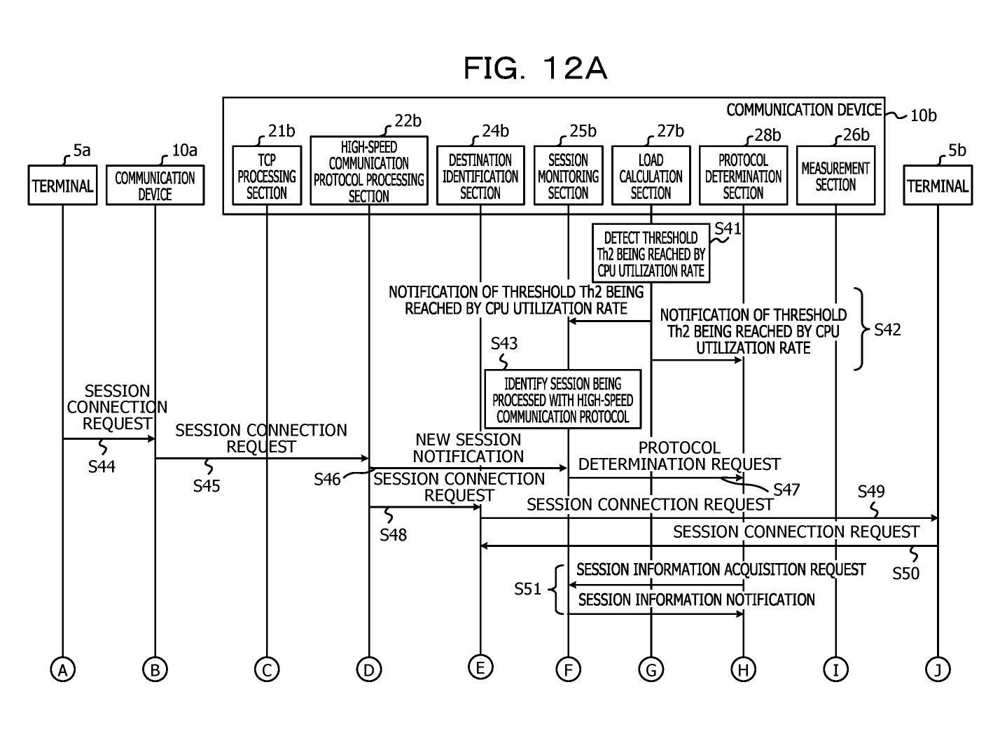

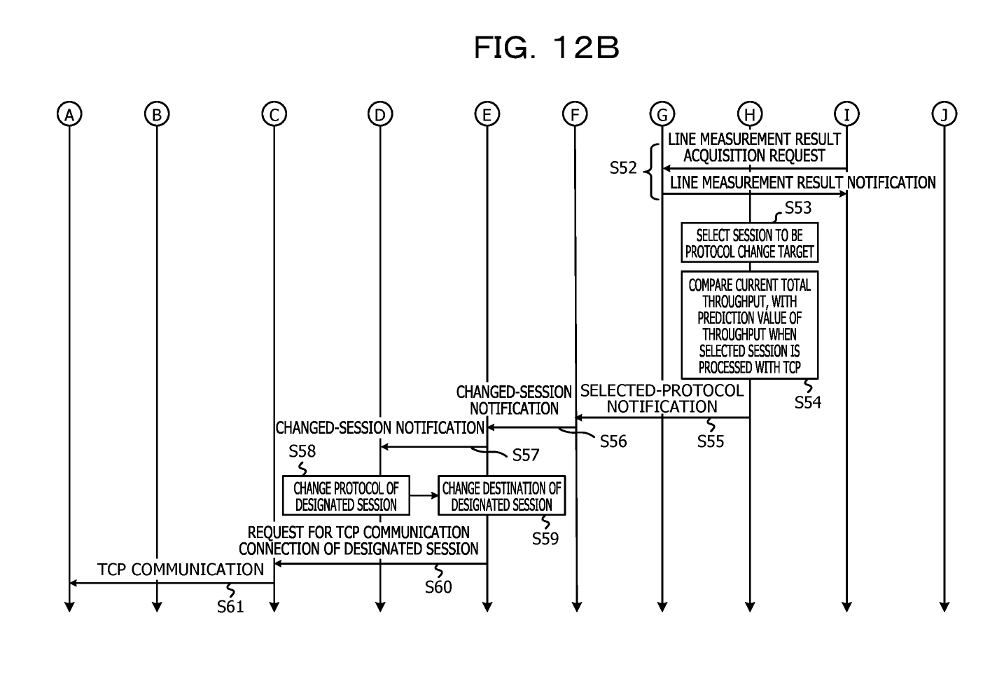

FIGS. 12A to 12B are a sequence diagram for describing an example of processing to be performed in the second embodiment. In FIGS. 12A to 12B, as with FIGS. 8A to 8B, the communication device 10a and the communication device 10b are assumed to relay the communication between the terminal 5a and the terminal 5b.

Upon detecting the threshold Th2 being reached by the CPU utilization rate, the load calculation section 27b notifies the session monitoring section 25b and the protocol determination section 28b that the threshold Th2 is reached by the CPU utilization rate (step S41 and step S42). Next, using the session management table 32b appropriately, the session monitoring section 25b identifies a session being processed with the high-speed communication protocol (step S43).

Processing in step S44 to step S50 is similar to that in step S3 to step S9 described with reference to FIG. 8A. In step S51, the protocol determination section 28b acquires information of the session being processed with the high-speed communication protocol, from the session monitoring section 25b. In this process, the session monitoring section 25b notifies the protocol determination section 28b of the information such as the latest throughput of each session, by appropriately using the session management table 32b and the path-status table 31b. Next, the protocol determination section 28b notifies the measurement section 26b of the connection source of each session being processed with the high-speed communication protocol, and acquires a measurement result for the state of the line with the communication device 10 serving as the connection source, from the measurement section 26b (step S52). In this process, the measurement section 26b searches through the path-status table 31b, and thereby notifies the protocol determination section 28b of the information such as the RTT and the packet loss rate between the communication device 10 notified of and the communication device 10b.

Using the values acquired from the measurement section 26b, and the throughput table 34b, the protocol determination section 28b determines a throughput to be obtained when the processing is performed using the TCP, for each session being currently processed with the high-speed communication protocol. Using the difference between the throughput when the TCP is used and the throughput based on the high-speed communication protocol, the protocol determination section 28b selects a session to be a target for the change of the protocol to be used for the processing, by the procedure described with reference to FIG. 11 (step S53). Next, the protocol determination section 28b calculates a total value of throughputs to be obtained when the sessions being processed with the high-speed communication protocol are processed with the high-speed communication protocol. Further, the protocol determination section 28b calculates a total throughput when the session selected as the target for the protocol change is processed with the TCP and the other sessions currently being established are processed with the high-speed communication protocol, as a prediction value of a throughput when the protocol change is performed. Furthermore, the protocol determination section 28b compares the total value of the throughputs when the sessions being processed are processed with the high-speed communication protocol, with the prediction value of the throughput when the protocol change is performed (step S54). As a result of the comparison, when the total value of the throughputs when the processing is performed with the high-speed communication protocol is larger, the protocol determination section 28b determines that the protocol to be used for the processing of the session being in the communication is not to be changed. On the other hand, when the prediction value of the throughput when the protocol change is performed is larger than the total value of the throughputs, the protocol determination section 28b determines that the session selected as the target for the protocol change is to be processed with the TCP.

The protocol determination section 28b notifies the session monitoring section 25b that the new session to be established is to be processed with the TCP. Further, when the protocol change is determined, the protocol determination section 28b notifies the session monitoring section 25b of the identifier of the session for which the protocol change is determined, and that the session is to be processed with the TCP (step S55). Processing for the new session to be established is similar to the processing described with reference to step S20 to step S23 in FIG. 8B.

Processing to be performed for the session for which the protocol is to be changed will be described with reference to step S56 and subsequent steps. In the following description, the connection source of the session for which the protocol is to be changed is the communication device 10a, and the endpoint of the session is the terminal 5. The session monitoring section 25b notifies the destination identification section 24b that the session for which the protocol is to be changed is to be terminated at the TCP processing section 21b (step S56). The destination identification section 24b notifies the high-speed communication protocol processing section 22b of the identifier of the session for which the protocol is to be changed, and that the session identified by the identifier notified of is to be processed with the TCP (step S57). The high-speed communication protocol processing section 22b performs processing for the change of the protocol of the designated session (step S58). To avoid disconnection of the session being in communication, the high-speed communication protocol processing section 22b appropriately notifies the TCP processing section 21b of information to be used for continuation of the session. This processing allows the TCP processing section 21b to acquire information such as a transmitted sequence for the session for which the protocol is changed, and to change the protocol, while avoiding the disconnection of the session being in communication. Upon completion of the processing for the change of the protocol, the high-speed communication protocol processing section 22b notifies the destination identification section 24b of the completion of the processing. Then, the destination identification section 24b performs processing of changing the destination of the packet for the session for which the protocol is to be changed, from the communication device 10a to the terminal 5a (step S59). To continue the session for which the protocol is to be changed, the TCP processing section 21b requests the destination identification section 24b to start TCP communication with the terminal 5a (step S60). The TCP processing section 21b then starts the TCP communication with the terminal 5a (step S61).

Although not illustrated in FIGS. 12A to 12B, the high-speed communication protocol processing section 22b notifies the communication device 10, which is the connection source for the session for which the protocol is changed, of the identifier of the session for which the protocol is to be changed. In this process, the high-speed communication protocol processing section 22b also notifies the communication device 10, which is the connection source, of information indicating that the session identified by the identifier is to be processed with the TCP, together with the identifier. This processing allows the communication device 10, which is the connection source, to recognize that the communication session for which the protocol change is notified of is to be processed with the TCP, and to update the session management table 32.

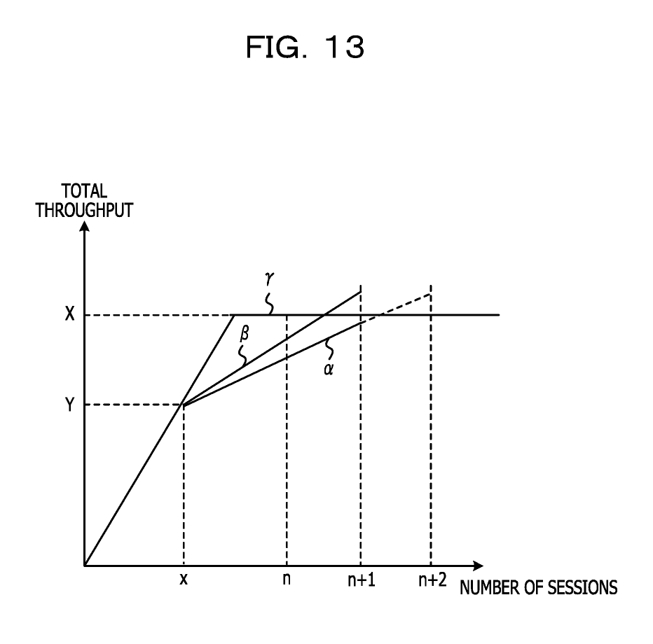

FIG. 13 is a diagram for describing an example of a prediction value of a throughput. Assume that the number of sessions being processed with the high-speed communication protocol is “n”, and the CPU utilization rate exceeds the threshold Th2. In addition, assume that, when the number of sessions being processed with the high-speed communication protocol is “x”, the CPU utilization is less than the threshold Th2. Further, a throughput when the number of sessions being processed with the high-speed communication protocol is “n” matches with a maximum X of a throughput to be obtained when the high-speed communication protocol is used, as indicated by “γ”.

When a throughput to be obtained using the TCP is relatively large, a throughput, which is to be obtained when a new session to be established and a session selected as a target for the protocol change are processed with the TCP, is a straight line as indicated by “β” in FIG. 13. In the case indicated by “β”, when the n sessions are processed with the high-speed communication protocol, a throughput, which is larger than a throughput when the high-speed communication protocol and the TCP are used together for the processing of the n sessions, is obtained. However, when n+1 sessions including the new session are processed, a throughput when the TCP and the high-speed communication protocol are used is larger than a throughput when only the high-speed communication protocol is used for the processing. Therefore, in a network where the throughput change indicated by “β” is obtained, in the processing in step S54 of FIG. 12B, the session selected as the target for the protocol change is processed with the TCP, and the new session is also processed with the TCP.

On the other hand, when a throughput to be obtained using the TCP is relatively small, a throughput, which is to be obtained when a new session to be established and a session selected as a target for the protocol change are processed with the TCP, is a straight line as indicated by “α” in FIG. 13. In the case indicated by “α”, when the n sessions are processed with the high-speed communication protocol, a throughput, which is larger than a throughput in a case where the high-speed communication protocol and the TCP are used together for the processing of the n sessions, is obtained. Further, when the n+1 sessions including the new session are processed, a throughput when only the high-speed communication protocol is used for the processing is larger than a throughput when the TCP and the high-speed communication protocol are used. Therefore, in a network where the throughput change indicated by “α” is obtained, in the processing in step S54 of FIG. 12B, the session selected as the target for the protocol change is processed with the high-speed communication protocol, and the new session is processed with the TCP.

In the network where the throughput changes as indicated by “α” in FIG. 13, when the next session is generated, the processing described in step S54 of FIG. 12B is also performed. In “α” in FIG. 13, a throughput to be obtained when n+2 sessions are processed with the high-speed communication protocol is smaller than a throughput to be obtained when the two sessions established last and the session selected as the target for the protocol change are processed with the TCP. Therefore, in the network where the throughput fluctuates as indicated by “α” in FIG. 13, processing of changing the protocol is performed when the n+2 sessions are established.

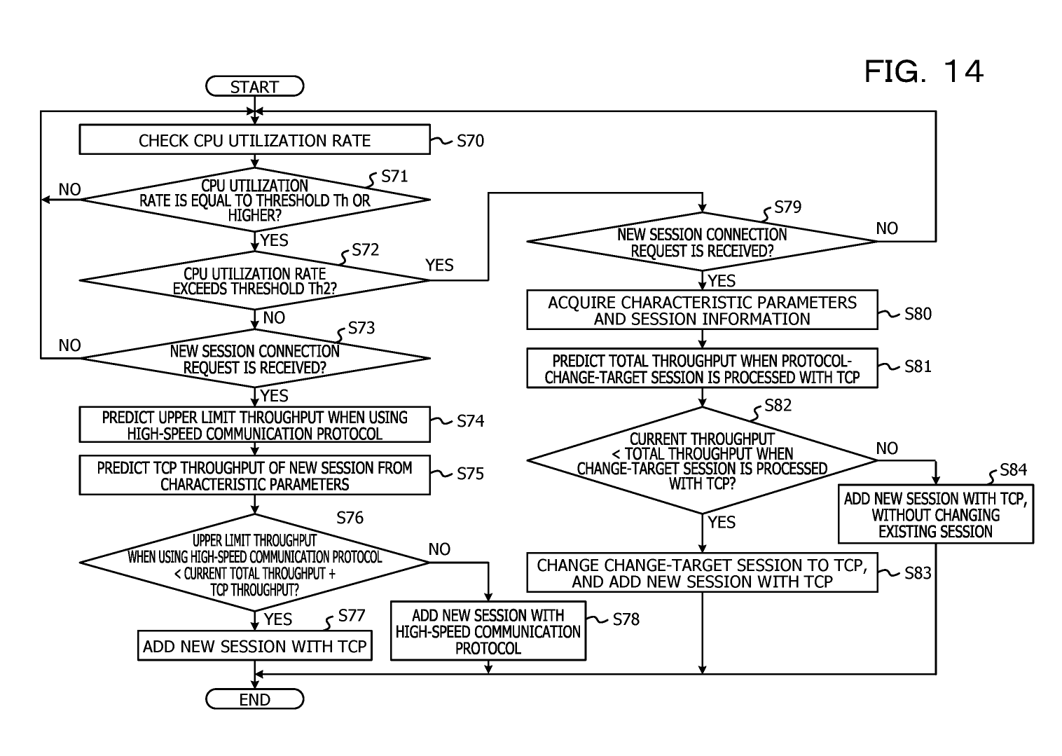

FIG. 14 is a flowchart for describing an example of processing to be performed in the second embodiment. The load calculation section 27 checks the CPU utilization rate, and determines whether the CPU utilization rate is equal to or higher than the threshold Th (step S70 and step S71). When the CPU utilization rate is less than the threshold Th (No in step S71), the processing returns to step S71. When the CPU utilization rate is equal to or higher than the threshold Th, the load calculation section 27 determines whether the CPU utilization rate exceeds the threshold Th2 (step S72). When the CPU utilization rate does not exceed the threshold Th2 (No in step S72), processing in step S73 to step S78 is performed. Here, the processing in step S73 to step S78 is similar to the processing in step S32 to step S37 described with reference to FIG. 10. Even if the CPU utilization rate exceeds the threshold Th2, the protocol determination section 28 waits until a connection request for a new session is received (No in step S79). When the CPU utilization exceeds the threshold Th2, and further, a connection request for a new session is received (Yes in step S79), the protocol determination section 28 acquires the characteristic parameters of the path between the communication devices 10 and information of each session (step S80). Next, using the acquired information, the protocol determination section 28 selects a session that may be a target for the processing of changing the protocol. The protocol determination section 28 calculates a prediction value of a throughput to be obtained when the session selected as the target for the protocol change is processed with the TCP (step S81). The protocol determination section 28 compares a throughput currently obtained with the high-speed communication protocol, with the prediction value of the throughput to be obtained when the session selected as the target for the protocol change is processed with the TCP (step S82). When the throughput currently obtained with the high-speed communication protocol is smaller (Yes in step S82), the protocol determination section 28 determines that the new session to be established and the session selected as the target for the protocol change are to be processed with the TCP (step S83). When the total value is smaller than the throughput currently obtained with the high-speed communication protocol (No in step S82), the protocol determination section 28 processes the new session with the TCP, without changing the protocol of the existing session (step S84).

As described in the second embodiment, changing the protocol to be used in some of the existing sessions makes it possible to reduce the CPU utilization rate, while optimizing the total value of the throughputs of the existing sessions.

### THIRD EMBODIMENT

In a third embodiment, there will be described a case where the communication device 10a, which directly receives a packet from the terminal 5a requesting the start of a session, determines a protocol to be used for processing of the session.

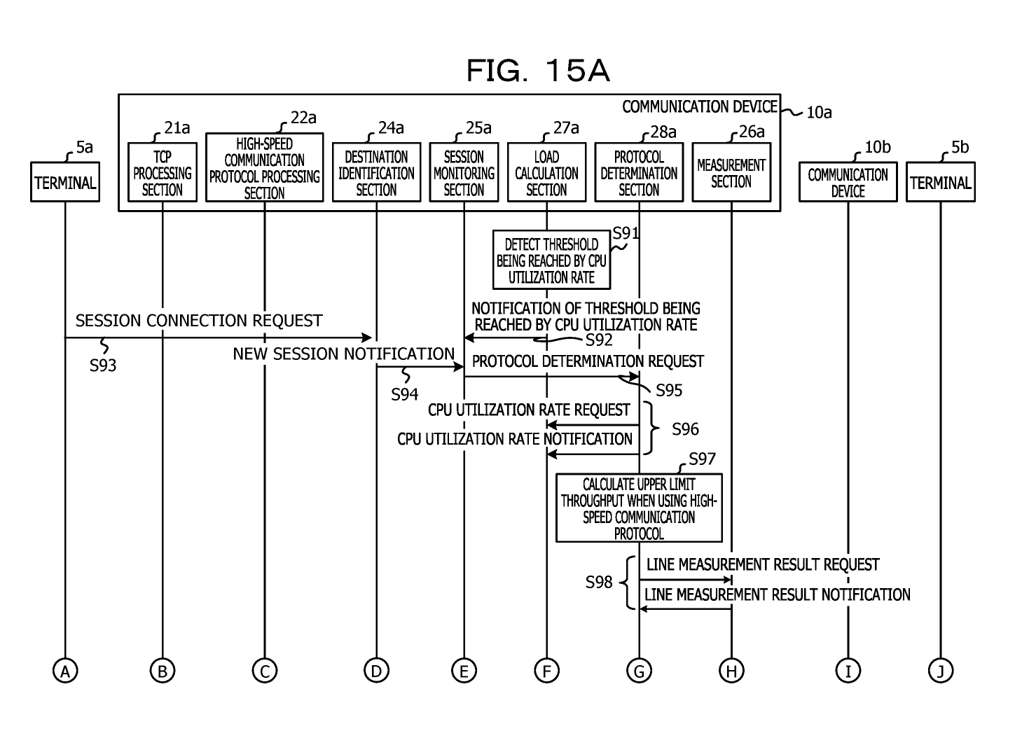

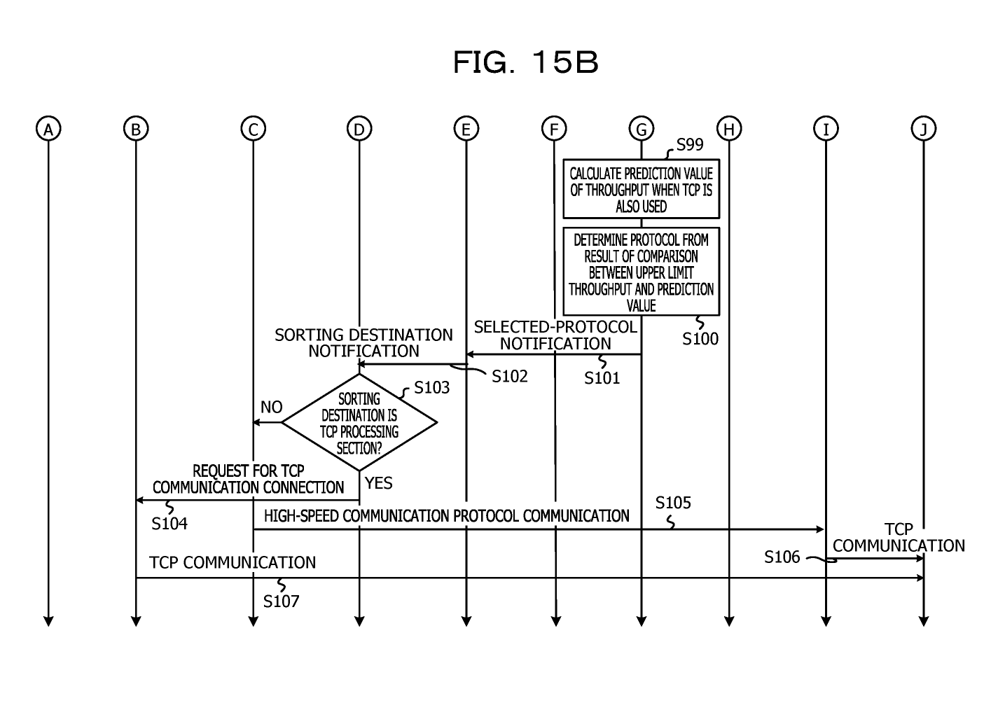

FIGS. 15A to 15B are a sequence diagram for describing an example of processing to be performed in the third embodiment. Processing in step S91 to step S93 is similar to the processing in step S1 to step S3 described with reference to FIG. 8A. Upon receiving a session connection request from the terminal 5a, the destination identification section 24a notifies the session monitoring section 25a that a new session is to be established (step S94). The session monitoring section 25a requests the protocol determination section 28a to determine a protocol to be used for processing of the new session to be established (step S95). Processing to be performed in step S96 to step S103 is similar to the processing in step S10 to step S17 described with reference to FIGS. 8A to 8B.

When being notified that a sorting destination for packets related to the new session to be connected is the high-speed communication protocol processing section 22a (No in step S103), the destination identification section 24a outputs a packet to be used for the establishment of the session to the high-speed communication protocol processing section 22b. In this case, the destination of the packet to be used for the establishment of the session is designated as the communication device 10b. Therefore, the high-speed communication protocol processing section 22a generates the session using the high-speed communication protocol with the communication device 10b, by transmitting the packet to the communication device 10b by using the high-speed communication protocol (step S105). In addition, the high-speed communication protocol processing section 22a in the communication device 10a adds the following entries to the session management table 32a.

Session number: Se2

Connection-source address: address of terminal 5a

Connection-destination address: address of communication device 10b

Protocol: high-speed communication protocol

When the session with the communication device 10a is generated by using the high-speed communication protocol, the communication device 10b establishes the TCP session with the terminal 5b (step S106). Further, the high-speed communication protocol processing section 22b adds information about the generated new session to the session management table 32b, as follows.

Session number: Se2

Connection-source address: address of communication device 10a

Connection-destination address: address of terminal 5b

Protocol: high-speed communication protocol

Therefore, the communication between the terminal 5a and the terminal 5b is performed via the session by the high-speed communication protocol between the communication device 10a and the communication device 10b.

On the other hand, when being notified that the new session to be connected is to be processed at the TCP processing section 21a (Yes in step S103), the destination identification section 24a outputs a packet to be used for the establishment of the session to the TCP processing section 21a (step S104). In this case, the address of the packet to be used for the establishment of the session is designated as the terminal 5b. The TCP processing section 21a generates the session using the TCP with the terminal 5b, by transmitting the packet to the terminal 5b by using the TCP (step S107). When performing the processing of transmission of the TCP session from the terminal 5a to the terminal 5b, the TCP processing section 21b of the communication device 10b updates the session management table 32b appropriately. Therefore, the information of the generated new session is recorded in the session management table 32b.

Processing after the session is established is similar to that in the first embodiment. In other words, the communication device 10a identifies a protocol to be used for the processing of transmission to the communication device 10b, according to the session management table 32a. The communication device 10b also determines a protocol to be used for the processing of the session, by using the session management table 32b.

As described in the third embodiment, when the communication device 10 receiving the session establishment request from the terminal 5 determines the protocol, the number of control signals is small as compared with that in the processing in the first embodiment described with reference to FIGS. 8A to 8B. Therefore, a burden on the network may be reduced.

### FOURTH EMBODIMENT

In a fourth embodiment, processing when the communication device 10 may use two or more high-speed communication protocols will be described.

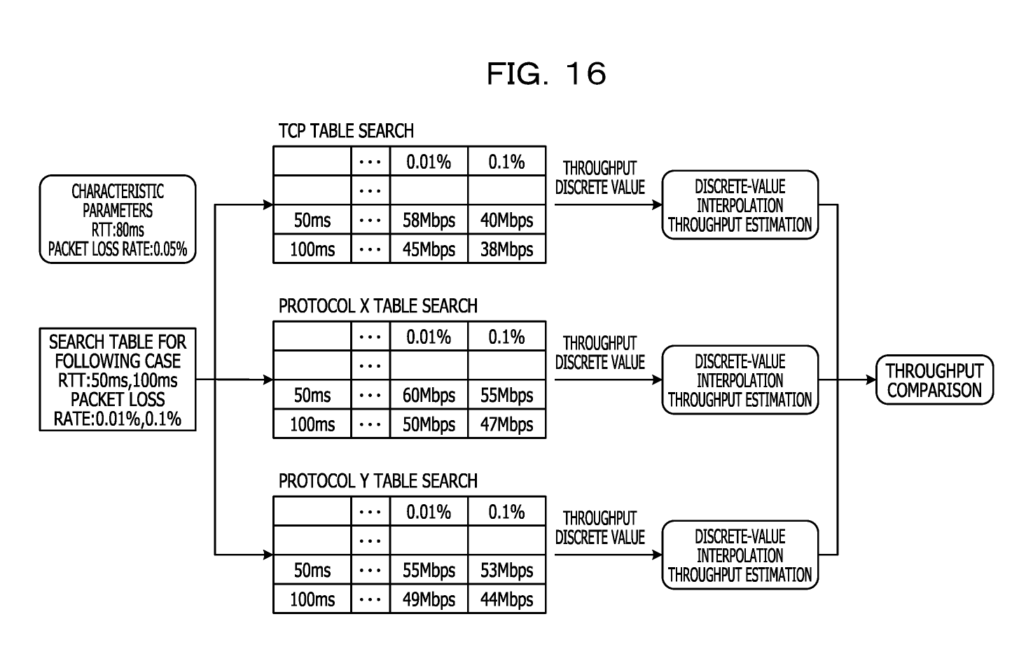

FIG. 16 is a diagram for describing an example of a throughput prediction method. When the communication device 10 may use two or more high-speed communication protocols, the throughput table 34 includes information available for prediction of a throughput for each of the high-speed communication protocols available in the communication device 10, in addition to the TCP. In the following, assume that, as illustrated in an example of FIG. 16, a protocol X and a protocol Y are the high-speed communication protocols to be used in the communication device 10. In this case, the throughput table 34 includes data for calculating a throughput for each of the TCP, the protocol X, and the protocol Y.

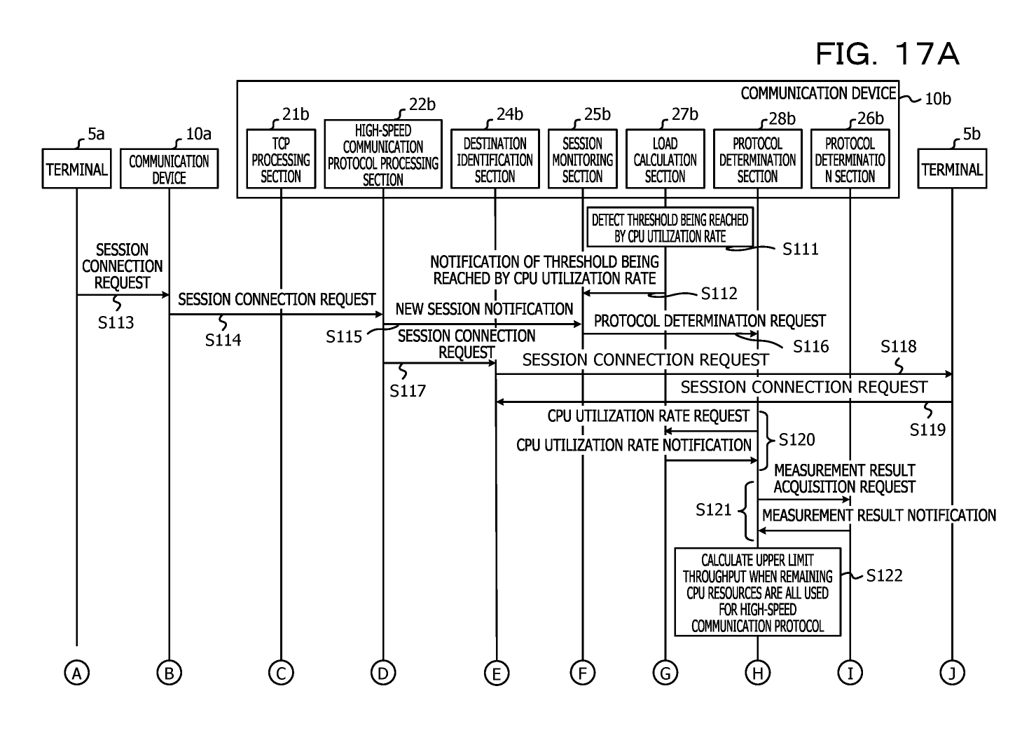

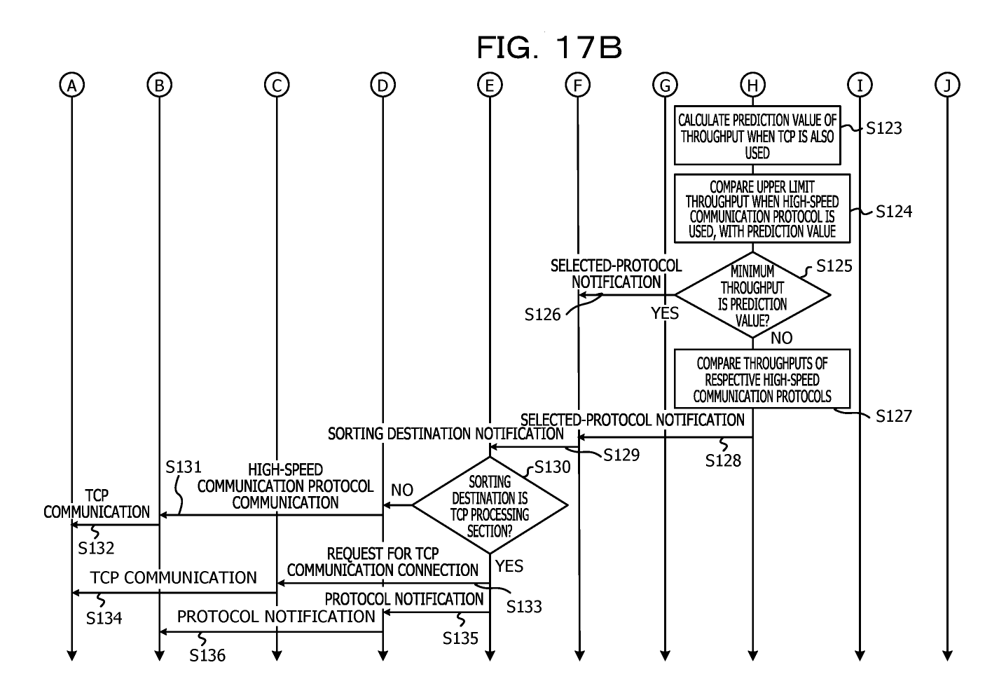

The protocol determination section 28 may determine the throughput in each of the protocols by linear interpolation processing, by using characteristic parameters of a line acquired from the measurement section 26. For example, assume that an RTT is 80 ms and a packet loss rate is 0.05%, in a line for which the throughput is to be predicted. For each of the protocols, the protocol determination section 28 identifies a throughput when the RTT is larger and the packet loss rate is also larger than those in the line to be processed, and a throughput when the RTT is larger and the packet loss rate is smaller than those in the line to be processed, from the session management table 32. Further, for each of the protocols, the protocol determination section 28 also identifies a throughput when the RTT is smaller and the packet loss rate is larger than those in the line to be processed, and a throughput when the RTT is smaller and the packet loss rate is smaller than those in the line to be processed. In the example of FIG. 16, a throughput in a case of RTT=50 ms and packet loss rate=0.01%, and a throughput in a case of RTT=100 ms and packet loss rate=0.01% are identified for each of the protocols. Furthermore, a throughput in a case of RTT=50 ms and packet loss rate=0.1%, and a throughput in a case of RTT=100 ms and packet loss rate=0.1% are also identified for each of the protocols. Using these values, a throughput when each of the protocols is used is estimated, by performing processing of calculation similar to the calculation described with reference to FIG. 9. Using the estimated throughput, the protocol determination section 28 determines a throughput for a new session to be established. A procedure of determining the throughput in the new session to be established will be described with reference to FIGS. 17A to 17B, in chronological order.

FIGS. 17A to 17B are a sequence diagram for describing an example of processing to be performed in the fourth embodiment. Processing to be performed in step S111 to step S120 is similar to the processing described with reference to step S1 to step S10 of FIG. 8A. The protocol determination section 28b acquires a measurement result for the state of the line with the communication device 10a, from the measurement section 26b (step S121). For each of the available high-speed communication protocols, the protocol determination section 28b predicts an upper limit throughput when all the remaining CPU resources are used for processing of the high-speed communication protocol (step S122). As described with reference to FIG. 16, the communication device 10 is assumed to be capable of using the protocol X and the protocol Y. In this case, the protocol determination section 28b determines an upper limit throughput when all the remaining CPU resources are used for processing of the protocol X, and an upper limit throughput when all the remaining CPU resources are used for processing of the protocol Y. Next, using the values acquired from the measurement section 26b, and the throughput table 34b, the protocol determination section 28b determines a throughput to be obtained when the TCP is used for processing of a new session to be established. Further, the protocol determination section 28b calculates a throughput to be obtained when the TCP is used for the processing of the new session to be established, as a prediction value of a throughput when the TCP, the protocol X, and the protocol Y are used together (step S123). Here, the prediction value is a total value of the throughput to be obtained when the TCP is used for the processing of the new session to be established, and the throughputs obtained by sessions currently being in communication.

The protocol determination section 28b compares the upper limit for the throughput to be obtained when each of the high-speed communication protocols is used, with the prediction value calculated in step S123 (step S124). Here, assume that the prediction value of the throughput when the TCP is used for the new session is higher than either the upper limit of the throughput when one of the high-speed communication protocols is used for the new session or the upper limit of the throughput when the other is used for the new session (Yes in step S125). In this case, the protocol determination section 28b selects a protocol to be used for the processing of the new session, in such a manner that the selected protocol achieves the highest total throughput, among the TCP and the high-speed communication protocols. The protocol determination section 28b notifies the session monitoring section 25b of the selected protocol (step S126).

On the other hand, assume that, in step S125, the throughput when the TCP is used is low, and the prediction value is lower than either of the upper limit for the throughput when the one of the high-speed communication protocols is used for the new session and the upper limit for the throughput when the other is used for the new session (No in step S125). In this case, the protocol determination section 28b determines that either one of the high-speed communication protocols is to be used for the communication between the communication device 10a and the communication device 10b. For each of the high-speed communication protocols, the protocol determination section 28b determines a throughput to be obtained when the high-speed communication protocol is used for the processing of the new session. When each of the high-speed communication protocols is used, a method of calculating the throughput to be obtained for the new session to be established is performed in a manner similar to the manner described with reference to FIG. 16. The protocol determination section 28b determines that the protocol, by which the throughput to be obtained for the new session is larger, is to be used for the new session (step S127). The protocol determination section 28b notifies the session monitoring section 25b of the selected protocol (step S128). The session monitoring section 25b records the protocol notified of by the protocol determination section 28b, in the session management table 32b. Processing to be performed in and after step S129 is similar to the processing performed in and after step S16 of FIG. 8B.

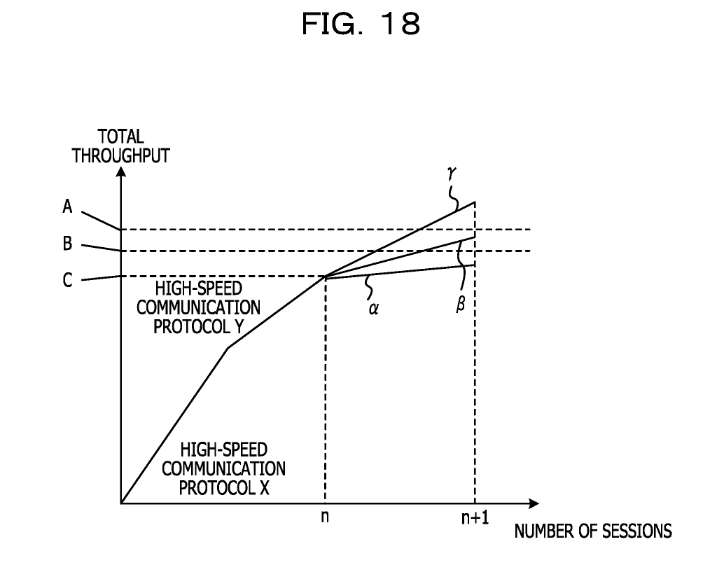

FIG. 18 is a diagram for describing an example of the prediction value of the throughput. The processing to be performed in step S125 to step S128 of FIG. 17B will be described in detail, with reference to FIG. 18. In FIG. 18, “A” represents an upper limit for throughputs to be obtained when the remaining CPU resources are used for processing of the protocol X, and “B represents an upper limit for throughputs to be obtained when the remaining CPU resources are used for processing of the protocol Y. Further, “C” in FIG. 18 represents a throughput obtained in the current processing. In addition, assume that n sessions are currently processed in the communication device 10.

In FIG. 18, each of “α” to “γ” represents an example of the throughput to be obtained when the TCP is used for processing of the new session to be established. When the communication status of the line between the communication device 10a and the communication device 10b is poor, the throughput when the new session is established with the TCP is a small value as indicated by “α”. In this case, the sum of the total value C of the throughputs in the n sessions currently being in communication and the throughput to be obtained when the new session is processed with the TCP is a value smaller than either of “A” and “B”. Therefore, as described in step S127 of FIG. 17B, the protocol determination section 28b determines that either of the high-speed communication protocols is to be used for the communication between the communication device 10a and the communication device 10b. For each of the high-speed communication protocols, the protocol determination section 28b determines a throughput to be obtained when the high-speed communication protocol is used for the processing of the new session, and the protocol, in which the determined throughput is larger, is used for the new session.

Next, with reference to “β” and “γ” of FIG. 18, there will be described a case where the throughput when the TCP is used for the new session is determined to be larger than the upper limit for the throughput to be obtained in either of the high-speed communication protocols in step S125 of FIG. 17B.

In “β” of FIG. 18, the throughput when the TCP is used for the new session is larger than the upper limit (B) for the throughput to be obtained when the processing using the protocol Y is performed with the remaining CPU resources. In addition, the throughput when the TCP is used for the new session is smaller than the upper limit (A) for the throughput to be obtained when the processing using the protocol X is performed with the remaining CPU resources. In this case, when the protocol X is used for the new session, a total value of the throughputs in all the sessions becomes a maximum and therefore, the protocol determination section 28b determines that the new session is to be processed with the protocol X.

In “γ” of FIG. 18, the throughput when the TCP is used for the new session is larger than the upper limit (A) for the throughput to be obtained when the processing using the protocol X is performed with the remaining CPU resources. In this case, when the TCP is used for the new session, a total value of the throughputs in all the sessions becomes a maximum and therefore, the protocol determination section 28 determines that the new session is to be processed with the protocol X.

As described in the fourth embodiment, when the communication device 10 may use a plurality of high-speed communication protocols, the protocol determination section 28b selects a protocol to be used for the processing of the new session, in such a manner that the total value of the throughputs in the sessions being in communication becomes a maximum. Therefore, in the communication device 10 using the plurality of high-speed communication protocols, likewise, a high throughput is obtained, and communication is performed efficiently.

Embodiments are not limited to those described above, and various modifications are allowed. Some of examples will be described.

In the second embodiment, an arbitrary number of sessions may each be selected as a target for the protocol change when the CPU utilization rate exceeds the threshold Th2. Further, when the number of sessions to be selected as the target for the protocol change is two or more, the CPU utilization rate may fall below the threshold Th2 to a large extent. In this case, since processing of a new session with the high-speed communication protocol is enabled by the protocol change, the new session to be established may be processed with the high-speed communication protocol. When the new session to be established may be processed with the high-speed communication protocol, a difference between a throughput when the TCP is used and a throughput when the high-speed communication protocol is used may be determined for the new session to be established as well. In this case, if the difference between the throughput with the TCP and the throughput with the high-speed communication protocol is large in the new session to be established, the new session may be processed with the high-speed communication protocol.

Any of the tables used for the above description is an example, and the information elements included in the tables may be changed according to implementation. Further, any of the packet formats is also an example and may be changed according to implementation.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A communication device comprising:
a memory; and
a processor coupled to the memory and configured to:
receive a connection request that requests a session,
calculate a processing load on processing of an ongoing session,
determine, when the processing load exceeds a threshold, each protocol for each of the requested session and the ongoing session based on a comparison of a first throughput and a second throughput, the first throughput being an estimated throughput when a first protocol is to be used for the requested session and the ongoing session, the second throughput being an estimated throughput when a second protocol is to be used for at least one of the requested session and the ongoing session, a processing load of the second protocol being smaller than a processing load of the first protocol, and
process each of the requested session and the ongoing session using each determined protocol.

2. The communication device according to claim 1, wherein
the second throughput is an estimated throughput when the second protocol is to be used for the requested session and the first protocol is to be used for the ongoing session, and
a protocol for the requested session is determined to be the second protocol when the second throughput is larger than the first throughput.

3. The communication device according to claim 2, wherein
the processor is further configured to estimate a third throughput when a third protocol is to be used for the requested session and the first protocol is to be used for the ongoing session, a processing load of the third protocol being smaller than a processing load of the first protocol and larger than a processing load of the second protocol,
a protocol for the requested session is determined to be the second protocol when the second throughput is larger than the first throughput and the third throughput, and
a protocol for the requested session is determined to be the third protocol when the second throughput is smaller than the first throughput and the third throughput and when the third throughput is larger than the first throughput.

4. The communication device according to claim 1, wherein
the processor is further configured to:
calculate each difference between each estimated throughput when the first protocol is used for each session and each estimated throughput when the second protocol is used for each session,
estimate a fourth throughput when a second protocol is to be used for a specified session whose calculated difference is smallest and the first protocol is to be used for a session other than the specified session, and
a protocol for the specified session is determined to be the second protocol when the fourth throughput is smaller than the first throughput.

5. The communication device according to claim 1, wherein
the requested session is used for communication between a terminal, having generated the connection request, and a destination via the communication device and another communication device,
the communication request is received from the terminal via the another communication device,
the processor is further configure to notify each determined protocol with information indicating the requested session, to the another communication device.

6. The communication device according to claim 1, wherein
the requested session is used for communication between a terminal, having generated the connection request, and a destination via the communication device and another communication device,
the communication request is received from the terminal,
the processor is further configure to transfer the requested session and the ongoing session to the another communication device using each determined protocol.

7. A communication processing method comprising:
receiving a connection request that requests a session;
calculating a processing load on processing of an ongoing session;
determining, when the processing load exceeds a threshold, each protocol for each of the requested session and the ongoing session based on a comparison of a first throughput and a second throughput, the first throughput being an estimated throughput when a first protocol is to be used for the requested session and the ongoing session, the second throughput being an estimated throughput when a second protocol is to be used for at least one of the requested session and the ongoing session, a processing load of the second protocol being smaller than a processing load of the first protocol; and
processing each of the requested session and the ongoing session using each determined protocol.

8. A non-transitory computer-readable storage medium storing a program that causes a computer to execute a process, the computer including a memory, the process comprising:
receiving a connection request that requests a session;
calculating a processing load on processing of an ongoing session;
determining, when the processing load exceeds a threshold, each protocol for each of the requested session and the ongoing session based on a comparison of a first throughput and a second throughput, the first throughput being an estimated throughput when a first protocol is to be used for the requested session and the ongoing session, the second throughput being an estimated throughput when a second protocol is to be used for at least one of the requested session and the ongoing session, a processing load of the second protocol being smaller than a processing load of the first protocol; and
processing each of the requested session and the ongoing session using each determined protocol.
